(19) United States
(12) Patent Application Publication
(10) Pub. No.: US 2026/0336971 A1
(43) Pub. Date: Oct. 29, 2026

(54) METHOD AND SYSTEM FOR ELEVATOR ASSIGNMENT IN AN ENVIRONMENT WHERE PEOPLE AND ROBOTS COEXIST, AND METHOD AND SYSTEM FOR ROBOT CONTROL FOR ELEVATOR BOARDING

(71) Applicant: NAVER CORPORATION, Seongnam-si (KR)

(72) Inventors: Seok Tae KIM, Seongnam-si (KR); Keun Jun CHOI, Seongnam-si (KR); Seung Hyun YOU, Seongnam-si (KR)

(73) Assignee: NAVER CORPORATION, Seongnam-si (KR)

(21) Appl. No.: 19/700,665

(22) Filed: Jun. 8, 2026

Related U.S. Application Data
(63) Continuation of application No. PCT/KR2024/004863, filed on Apr. 11, 2024.

(30) Foreign Application Priority Data
Dec. 7, 2023 (KR) 10-2023-0177057

(51) Int. Cl. B66B 1/34; B66B 1/06; B66B 1/46

(52) U.S. Cl. CPC B66B 1/3407; B66B 1/06; B66B 1/468; B66B 2201/23; B66B 2201/401; B66B 2201/403; B66B 2201/405; B66B 2201/4638

(57) ABSTRACT

The present disclosure relates to a method and system for elevator assignment in a building where people and robots coexist. The elevator assignment method according to the present disclosure may comprise: classifying a plurality of time periods into one of a first type of time period or a second type of time period based on elevator usage patterns of people in the building, and specifying a number of elevators to be assigned to the robot among a plurality of elevators provided in the building, depending on whether a particular time period is the first type of time period or the second type of time period; wherein in the first type of time period, a portion of the plurality of elevators may be assigned to the robot, and in the second type of time period, an entirety of the plurality of elevators may be assigned to the robot.

### CROSS-REFERENCE TO RELATED APPLICATION

This application is a continuation of, and claims the benefit of priority under 35 U.S.C. § 365(c) from International Application No. PCT/KR 2024/004863, filed on Apr. 11, 2024, in the World Intellectual Property Organization (WIPO), which designates the United States of America and claims priority benefit of Korean Patent Application No. 10-2023-0177057, filed on Dec. 7, 2023, the disclosures of each of which are incorporated herein by reference in their entireties.

### BACKGROUND

As technology advances, various service devices are emerging, and in particular, technology development for robots that perform various tasks or services has been actively conducted in recent years.

Furthermore, in recent years, as artificial intelligence technology, cloud technology, and the like have advanced, it has become possible to control robots more precisely and safely, and accordingly, the utilization of robots is gradually increasing.

In particular, due to advances in technology, robots have reached a level at which they can safely coexist with humans in indoor spaces.

Accordingly, robots have recently been replacing human tasks or work, and in particular, various methods by which robots directly provide services to people in indoor spaces have been actively studied.

For example, robots are providing navigation services in public places such as airports, train stations, and department stores, and robots are providing serving services in restaurants.

Furthermore, in office spaces, shared residential spaces, and the like, robots are providing delivery services for mail, parcels, and the like.

In addition, robots are providing various services such as cleaning services, security services, and logistics processing services, and the types and scope of services provided by robots are expected to increase exponentially in the future, and the level of service provision is also expected to continue to develop.

Such robots are providing various services not only in outdoor spaces but also within indoor spaces of buildings (or structures) such as offices, apartments, department stores, schools, hospitals, and amusement facilities, and in this case, the robots are controlled to move through the indoor spaces of the building and provide various services.

Meanwhile, in order to provide various tasks or services with robots, the robots should be controlled accurately.

Because there are practical limitations to users individually controlling robots in the vicinity of the robots, the need for technologies that enable the remote control of robots is increasing.

Furthermore, constraints on the space in which robots move should be further relaxed. To this end, various research activities are currently underway to enable robots to board means of transportation, such as elevators, automobiles, and electric carts.

For example, centralized control may be performed over elevators and robots to enable a robot to board an elevator.

When having robots board a transportation device, various factors should be considered from the perspective of robot and/or robot service operation, regarding methods to efficiently coordinate the relationship between the robot and people using the transportation device and robots.

### SUMMARY

Some example embodiments of the present disclosure provide methods and/or systems for assigning elevators to people and/or robots in an environment where people and robots coexist.

Some example embodiments of the present disclosure provide methods and/or systems for controlling a robot for boarding an elevator assigned to the robot.

Some example embodiments of the present disclosure provide methods and/or systems for assigning elevators in an environment where people and robots coexist.

Furthermore, some example embodiments of the present disclosure provide methods and/or systems for controlling a robot for elevator boarding.

Furthermore, some example embodiments of the present disclosure provide methods and/or systems for controlling an elevator and a robot in conjunction with each other so that the elevator may be operated efficiently in a building where people and robots coexist.

According to an example embodiment of the present disclosure, a method for elevator assignment in a building where people and robots coexist may include classifying a plurality of time periods into one of a first type of time period or a second type of time period based on elevator usage patterns of people in the building, and specifying a number of elevators to be assigned to the robot among a plurality of elevators provided in the building, depending on whether a particular time period is the first type of time period or the second type of time period, wherein the number of elevators assigned to the robot in the first type of time period is less than the number of elevators assigned to the robot in the second type of time period.

Furthermore, According to an example embodiments of the present disclosure, a system for elevator assignment in a building where people and robots coexist may include a controller configured to classify a plurality of time periods into one of a first type of time period or a second type of time period based on elevator usage patterns of people in the building, and specify a number of elevators to be assigned to a robot among a plurality of elevators provided in the building, depending on whether a particular time period is the first type of time period or the second type of time period, wherein the number of elevators assigned to the robot in the first type of time period is less than the number of elevators assigned to the robot in the second type of time period.

Furthermore, according to an example embodiments of the present disclosure, there i provided a non-transitory computer-readable recording medium storing a program thereon, which when executed by one or more processors in an electronic device, causes the electronic device to implement a method for elevator assignment in a building where people and robots coexist. The method may include, classifying a plurality of time periods into one of a first type of time period or a second type of time period based on elevator usage patterns of people in the building, and specifying a number of elevators to be assigned to a robot among a plurality of elevators provided in the building, depending on whether a particular time period is the first type of time period or the second type of time period, wherein the number of elevators assigned to the robot in the first type of time period is less than the number of elevators assigned to the robot in the second type of time period.

The elevator assignment method and system according to some example embodiments of the present disclosure may classify a plurality of time periods into one of a first type of time period or a second type of time period based on elevator usage patterns of people in the building, and may specify a number of elevators to be assigned to the robot among a plurality of elevators provided in the building, depending on whether a particular time period is the first type of time period or the second type of time period.

Through this, some example embodiments of the present disclosure may reduce or minimize inconvenience to people regarding elevator use in an environment where people and robots coexist, and may provide an improved or optimal elevator assignment approach capable of improving the efficiency of elevator use.

Furthermore, the elevator assignment method and system according to some example embodiments of the present disclosure assign a portion of the plurality of elevators to a robot in the first type of time period and assign an entirety of the plurality of elevators to the robot in the second type of time period, thereby providing an environment capable of satisfying the elevator usage demand of people for each of the plurality of time periods while simultaneously providing robot services.

Furthermore, the robot-compatible building according to some example embodiments of the present disclosure utilizes technological convergence in which robot, autonomous driving, Artificial Intelligence (AI), and/or cloud technologies are converged and connected, and may provide a new space in which such technologies, robots, and facility infrastructure provided within the building are organically combined.

Furthermore, the robot-compatible building according to the present disclosure may systematically manage the travel of robots that provide services in a more organized manner by organically controlling a plurality of robots and facility infrastructure using a cloud server that interoperates with the plurality of robots.

Through this, the robot-compatible building according to the present disclosure may provide various services to people more safely, quickly, and accurately.

### BRIEF DESCRIPTION OF THE DRAWINGS

FIGS. 1, 2, and 3 are conceptual diagrams for explaining a robot-compatible building according to some example embodiments of the present disclosure.

FIGS. 4, 5, and 6 are conceptual diagrams for explaining a robot traveling in a robot-compatible building according to some example embodiments of the present disclosure and a system for controlling various facilities provided in the robot-compatible building.

FIGS. 7 and 8 are conceptual diagrams for explaining facility infrastructure provided in a robot-compatible building according to some example embodiments of the present disclosure.

FIGS. 9 through 11 are conceptual diagrams for explaining a method for estimating a location of a robot traveling in a robot-compatible building according to some example embodiments of the present disclosure.

FIG. 12 is a conceptual diagram for explaining a system for assigning an elevator and controlling a robot for elevator boarding in an environment where people and robots coexist.

FIG. 13 is a flowchart for explaining the interlocking of a robot and an elevator in an example embodiment of the present disclosure.

FIG. 14 is a conceptual diagram for explaining an operation mode of an elevator in an environment where people and robots coexist.

FIG. 15 is a flowchart for explaining a method of assigning an elevator and controlling a robot for boarding the elevator in an environment where people and robots coexist.

FIGS. 16A, 16B, 16C, and 16D are conceptual diagrams for explaining a method of assigning an elevator in an environment where people and robots coexist.

FIGS. 17A, 17B, 17C, and 17D are conceptual diagrams for explaining a method of assigning an elevator based on a robot group and controlling the robot group for boarding the elevator.

FIGS. 18A, 18B, 18C, 18D, and 18E are conceptual diagrams for explaining a method of assigning an elevator according to a travel direction of people and controlling a robot for boarding the elevator in an environment where people and robots coexist.

### DETAILED DESCRIPTION

Hereinafter, some example embodiments disclosed in the present specification will be described in detail with reference to the accompanying drawings, wherein the same reference numerals are assigned to the same or similar components regardless of reference numerals, and redundant descriptions thereof will be omitted. The suffixes “module” and “unit” for components used in the following description are given or used interchangeably in consideration of ease of drafting the specification only, and do not themselves have meanings or roles that distinguish them from each other. Furthermore, in describing the example embodiments disclosed in the present specification, if it is determined that a detailed description of related known technology may obscure the gist of the example embodiments disclosed in the present specification, the detailed description thereof will be omitted. Furthermore, the accompanying drawings are for facilitating understanding of the example embodiments disclosed in the present specification, and the technical ideas disclosed in the present specification are not limited by the accompanying drawings, and it should be understood that all changes, equivalents, and substitutes included in the spirit and technical scope of the present disclosure are included.

Terms including ordinal numbers such as first, second, etc. may be used to describe various components, but the components are not limited by the terms. The terms are used for the purpose of distinguishing one component from another component.

When a component is referred to as being “connected” or “coupled” to another component, it should be understood that the component may be directly connected or coupled to the other component, but another component may exist in between. On the other hand, when a component is referred to as being “directly connected” or “directly coupled” to another component, it should be understood that no other component exists in between.

Singular expressions include plural expressions unless the context clearly indicates otherwise.

In the present application, terms such as “comprise” or “have” are intended to designate the existence of features, numbers, steps, operations, components, parts, or combinations thereof described in the specification, and should be understood as not precluding the possibility of the existence or addition of one or more other features, numbers, steps, operations, components, parts, or combinations thereof.

As used herein, expressions such as “one of,” “one or more of,” “any one of,” “at least one of,” “at least one among,” and “at least one selected from” when preceding a list of elements, modify the entire list of elements and do not modify the individual elements of the list. Thus, for example, both “(at least) one of A, B, or C” and “(at least) one of A, B, and C” mean either A, B, C, or any combination thereof. Likewise, A and/or B means A, B, or A and B.

The present disclosure relates to a robot-compatible building, and proposes a robot-compatible building in which people and robots can safely coexist and, furthermore, robots can provide beneficial services within the building.

More specifically, the present disclosure provides a method of providing useful services to people by using robots, robot-compatible infrastructure, and/or various systems for controlling the same. In a building according to the present disclosure, people and a plurality of robots may coexist, and various infrastructure (or facility infrastructure) enabling a plurality of robots to move freely within the building may be provided.

In the present disclosure, a building is a structure built for continuous residence, living, work, and the like, and may take various forms such as commercial buildings, industrial buildings, institutional buildings, and residential buildings. Furthermore, the building may be a multi-story building having a plurality of floors or a single-story building. However, in the present disclosure, infrastructure or facility infrastructure applied to a multi-story building will be described as an example for convenience of explanation.

In the present disclosure, infrastructure or facility infrastructure refers to facilities provided in a building for service provision, robot movement, function maintenance, cleanliness maintenance, and the like, and the types and forms thereof may vary greatly. For example, the infrastructure provided in a building may vary, such as movement facilities (e.g., robot movement passages, elevators, escalators, etc.), charging facilities, communication facilities, cleaning facilities, structures (e.g., stairs, etc.), and the like. In the present specification, such facilities are referred to as facilities, infrastructure, or facility infrastructure, and the terms may be used interchangeably as the case may be.

Furthermore, in the building according to some example embodiments of the present disclosure, at least one of the building, various facility infrastructure provided in the building, or the robots may be controlled in conjunction with each other, so that the robots can safely and accurately provide various services within the building.

The present disclosure proposes a building equipped with various facility infrastructure capable of supporting a plurality of robots traveling within the building, providing services according to missions (or tasks), and supporting standby or charging functions as desired, as well as repair and cleaning functions for the robots. Such a building provides an integrated solution (or system) for robots, and a building according to the present disclosure may be named with various descriptors. For example, a building according to the present disclosure may be expressed in various ways, such as i) a building equipped with infrastructure used by robots, ii) a building equipped with robot-compatible infrastructure, iii) a robot-compatible building, iv) a building where robots and people live together (e.g., coexist), and v) a building that provides various services using robots.

Meanwhile, the meaning of “robot-compatible” in the present disclosure refers to a building in which robots coexist, and more specifically, may mean that travel by robots is permitted, that robots provide services, that facility infrastructure usable by robots is established, or that facility infrastructure providing functions desired for robots (e.g., charging, repair, cleaning, etc.) is established. In this case, “robot-compatible” in the present disclosure may be used to mean that an integrated solution for the coexistence of robots and people is provided.

Hereinafter, the present disclosure will be described in more detail with reference to the accompanying drawings.

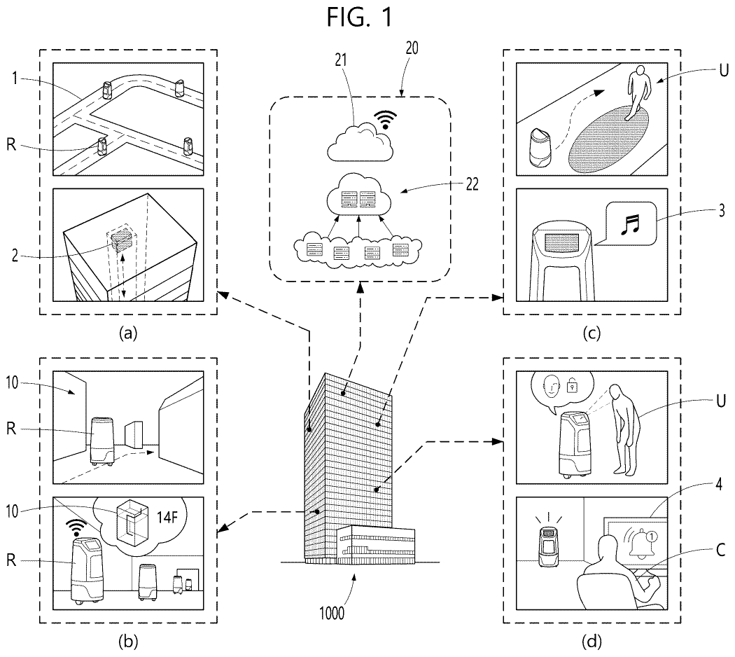

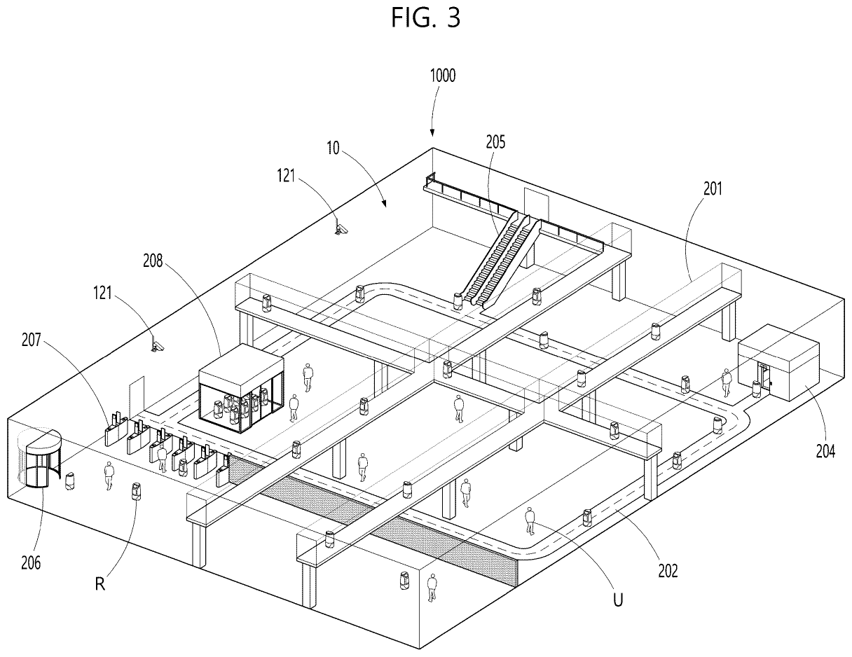

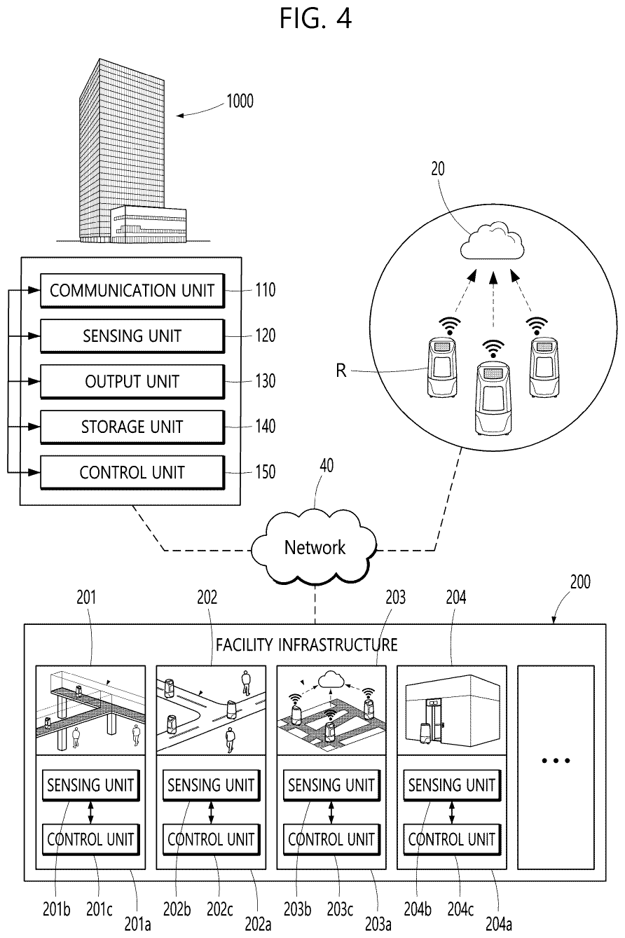

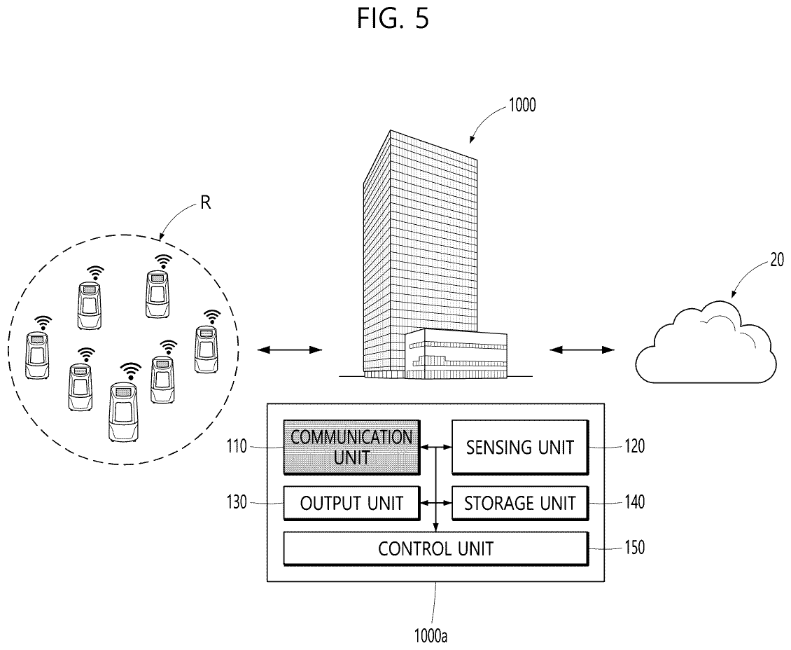

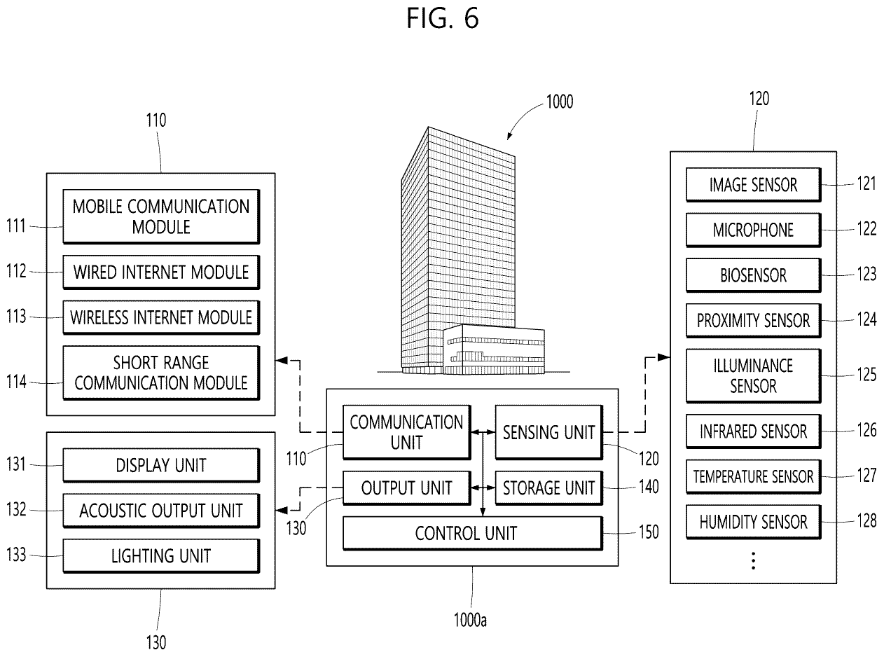

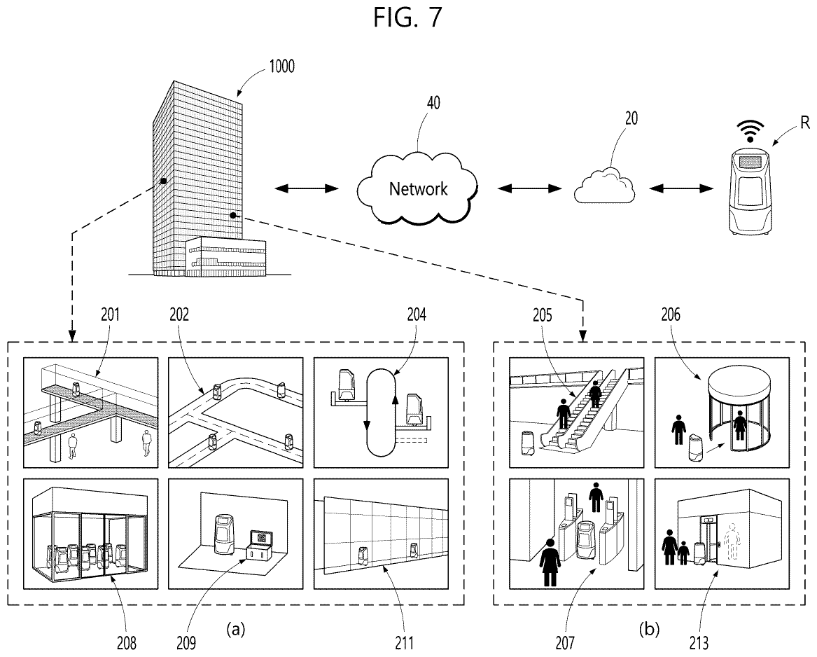

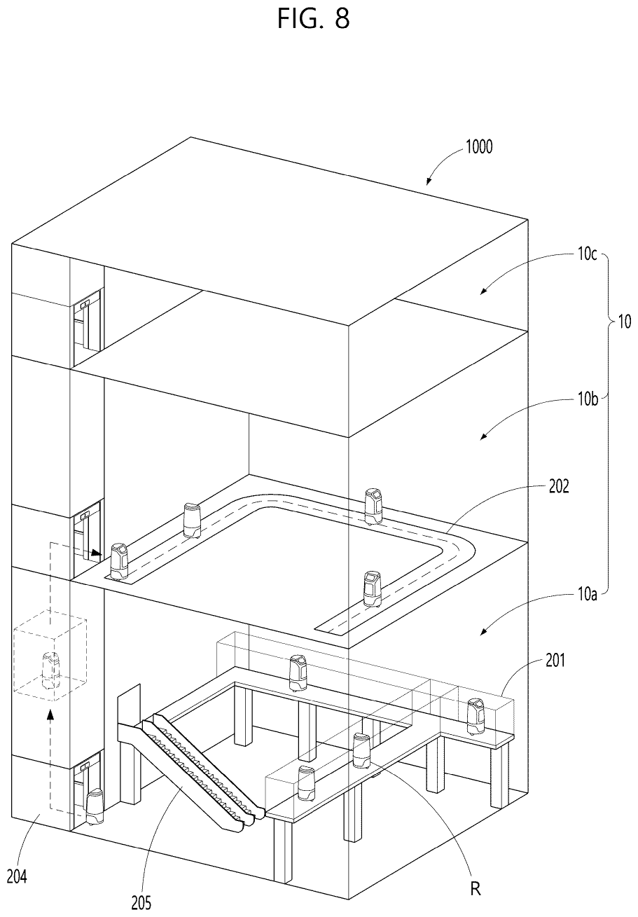

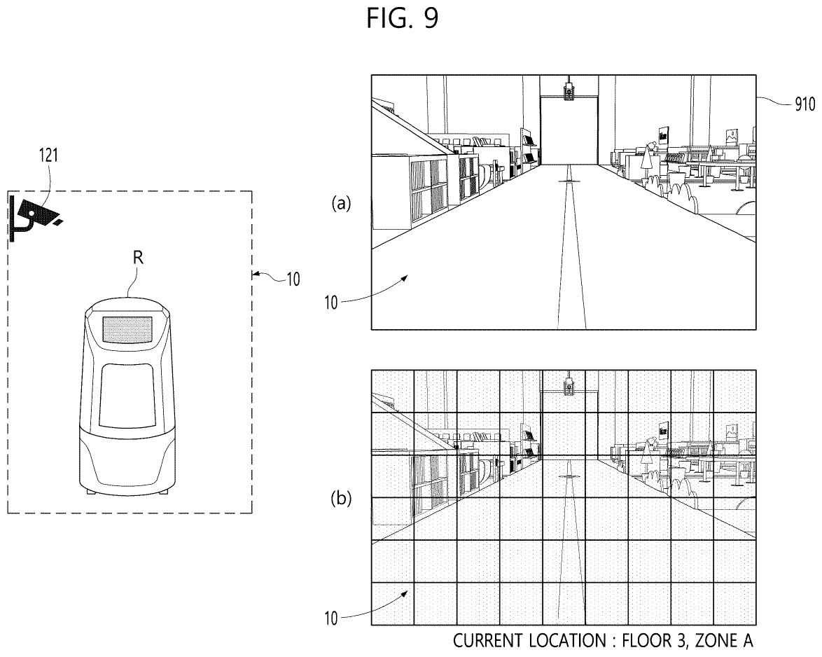

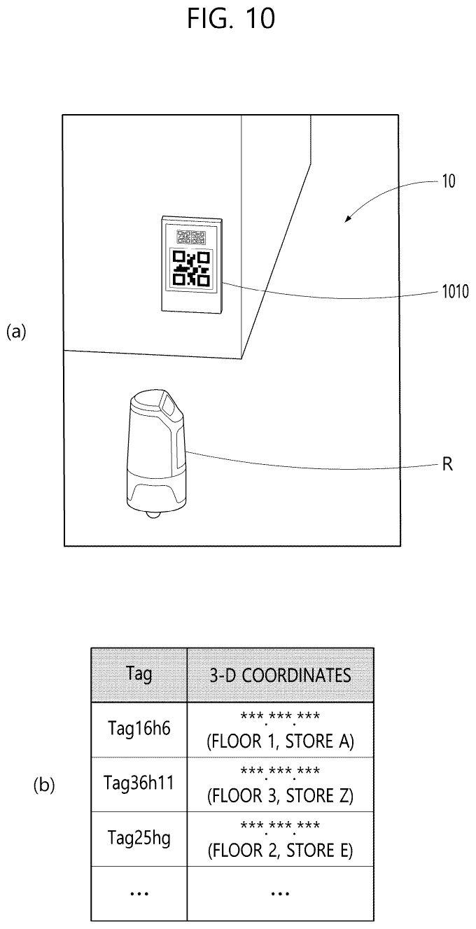

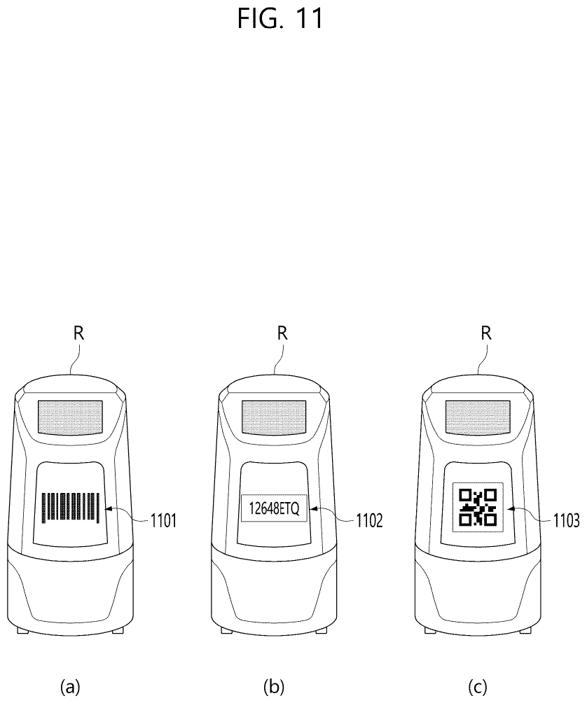

FIGS. 1, 2, and 3 are conceptual diagrams for explaining a robot-compatible building according to some example embodiments of the present disclosure, and FIGS. 4, 5, and 6 are conceptual diagrams for explaining a robot traveling in a robot-compatible building according to some example embodiments of the present disclosure and a system for controlling various facilities provided in the robot-compatible building. Furthermore, FIGS. 7 and 8 are conceptual diagrams for explaining facility infrastructure provided in a robot-compatible building according to some example embodiments of the present disclosure. FIGS. 9 to 11 are conceptual diagrams for explaining a method of estimating a position of a robot traveling in a robot-compatible building according to some example embodiments of the present disclosure.

First, for convenience of explanation, representative reference numerals will be defined.

In the present disclosure, the building is assigned reference numeral 1000, and the space (indoor space or indoor area) of the building 1000 is assigned reference numeral “10” (see FIG. 8). Furthermore, indoor spaces corresponding to a plurality of floors constituting the indoor space of the building 1000, respectively, are assigned reference numerals 10a, 10b, 10c, and the like, (see FIG. 8). In the present disclosure, an indoor space or indoor area refers to the interior of a building protected by an outer wall, as a concept opposite to the exterior of the building, and is not limited to meaning a space.

Furthermore, in the present disclosure, the robot is assigned reference numeral “R”, and even if a reference numeral is not written for a robot in the drawings or the specification, all robots may be understood as the robot R.

Furthermore, in the present disclosure, a person or human is assigned reference numeral “U”, and a person or human may be named or referred to as a dynamic object.

In this case, a dynamic object does not necessarily mean only a person, but may be understood to include objects capable of movement, such as animals like dogs and cats, at least one other robot (e.g., a user's personal robot, a robot providing other services, etc.), drones, and cleaners (e.g., robot cleaners).

Meanwhile, the building (structure, edifice) 1000 described in the present disclosure is not limited to any particular type, and may refer to a structure built for people to live in, work in, raise animals in, or store goods in.

For example, the building 1000 may be an office, an officetel, an apartment, a mixed-use residential and commercial apartment, a house, a school, a hospital, a restaurant, a government office, or the like, and the present disclosure may be applied to these various types of buildings.

As shown in FIG. 1, in the building 1000 according to the present disclosure, a robot may travel and provide various services.

One or more different types of robots may be located within the building 1000, and these robots may, under the control of the server 20, travel within the building 1000, provide services, and use various facility infrastructure provided in the building 1000.

In the present disclosure, the server 20 may be located in various places. For example, the server 20 may be located in at least one of the interior of the building 1000 or the exterior of the building 1000. That is, at least a portion of the server 20 may be located inside the building 1000, and the remaining portion of the server 20 may be located outside the building 1000. Alternatively, the server 20 may be located entirely inside the building 1000 or only outside the building 1000. Accordingly, in the present disclosure, no particular limitation is placed on the specific location of the server 20.

Furthermore, the server 20 in some example embodiments of the present disclosure may be configured to use at least one of a cloud computing server (cloud server, 21) or an edge computing server (edge server, 22). Furthermore, any server 20 may be applied to the example embodiments of the present disclosure as long as the server is configured to control robots, in addition to cloud computing or edge computing methods.

Meanwhile, the server 20 according to some example embodiments of the present disclosure may, in some cases, perform control of at least one of the robots or control the facility infrastructure provided in the building 1000 by combining the cloud computing server 21 and the edge computing method.

Meanwhile, the robot R may be driven according to a control command. For example, the robot R may change its position or posture by changing its movement, and may perform software updates.

In the present disclosure, for convenience of explanation, the server 20 is consistently referred to as a “cloud server” and is assigned reference numeral “20”. Meanwhile, such a cloud server 20 may also be referred to by the term “edge server 22” of edge computing.

Furthermore, the term “cloud server” may be variously changed to terms such as cloud robot system, cloud system, cloud robot control system, cloud control system, and the like.

Meanwhile, the cloud server 20 according to some example embodiments of the present disclosure may be configured to perform integrated control of a plurality of robots traveling in the building 1000. That is, the cloud server 20 may i) perform monitoring of a plurality of robots R located in the building 1000, ii) assign tasks (or tasks) to the plurality of robots, iii) directly control the facility infrastructure provided in the building 1000 so that the plurality of robots R can successfully perform their tasks, and/or iv) cause the facility infrastructure to be controlled through communication with a control system that controls the facility infrastructure.

Furthermore, the cloud server 20 may check status information of robots located in the building and provide (or support) various functions desired for the robots. Here, the various functions may include a charging function for the robots, a cleaning function for contaminated robots, a standby function for robots that have completed their tasks, and the like.

The cloud server 20 may control the robots so that the robots use various facility infrastructure provided in the building 1000, in order to provide various functions to the robots. Furthermore, the cloud server 20 may directly control the facility infrastructure provided in the building 1000, or cause the facility infrastructure to be controlled through communication with a control system that controls the facility infrastructure, in order to provide various functions to the robots.

In this way, robots controlled by the cloud server 20 may travel through the building 1000 and provide various services.

Meanwhile, the cloud server 20 may perform various controls based on information stored in a database, and no particular limitation is placed on the type and/or location of the database in the present disclosure. The term “database” may be freely modified and used as long as it refers to any medium for storing information, such as memory, storage unit, storage, cloud storage, external storage, external server, and the like. Hereinafter, the description will consistently use the term “database”.

Meanwhile, the cloud server 20 according to some example embodiments of the present disclosure may perform distributed control of robots based on various criteria such as the types of services provided by the robots and/or the types of control for the robots, and in this case, subordinate sub-servers of a lower-level concept may exist in the cloud server 20.

Furthermore, the cloud server 20 according to some example embodiments of the present disclosure may control robots traveling in the building 1000 based on various artificial intelligence algorithms.

Furthermore, the cloud server 20 may perform artificial intelligence-based learning that utilizes data collected in the process of controlling robots as learning data, and by applying such learning to the control of the robots, the robots may be operated more accurately and efficiently as the control of the robots is performed. That is, the cloud server 20 may be configured to perform deep learning or machine learning. In addition, the cloud server 20 may perform deep learning or machine learning through simulation and the like, and may perform the control of the robots using an artificial intelligence model constructed as a result thereof.

Meanwhile, the building 1000 may be equipped with various facility infrastructure for robot travel, provision of robot functions, maintenance of robot functions, performance of robot tasks, or coexistence of robots and people.

For example, as shown in (a) of FIG. 1, various facility infrastructure 1, 2 capable of supporting travel (or movement) of the robot R may be provided within the building 1000. Such facility infrastructure 1, 2 may support movement of the robot R in a horizontal direction within a floor of the building 1000, or may support movement in a vertical direction so that the robot R moves between different floors of the building 1000. In this way, the facility infrastructure 1 and 2 may include a transportation system that supports movement of the robot. The cloud server 20 may control the robot R to use such various facility infrastructure 1 and 2, so that the robot R moves within the building 1000 to provide services, as shown in (b) of FIG. 1.

Meanwhile, robots according to some example embodiments of the present disclosure may be controlled based on at least one of the cloud server 20 or a control unit provided in the robot itself, so as to travel within the building 1000 or provide a service corresponding to an assigned task.

Furthermore, as shown in (c) of FIG. 1, the building according to some example embodiments of the present disclosure is a building where robots and people coexist, and the robots are configured to travel while avoiding obstacles such as people U, objects used by people (e.g., strollers, carts, etc.), and/or animals, and may be configured to output notification information 3 related to robot travel in some cases. Such travel of the robot may be performed to avoid obstacles based on at least one of the cloud server 20 or a control unit provided in the robot. The cloud server 20 may perform control of the robot so that the robot avoids obstacles and moves within the building 1000, based on information received through various sensors provided in the robot (e.g., a camera (image sensor), a proximity sensor, an infrared sensor, etc.).

In addition, a robot traveling within the building through the processes of (a) to (c) of FIG. 1 may be configured to provide a service to a person or a target object present in the building, as shown in (d) of FIG. 1.

The type of service provided by a robot may differ for each robot. That is, robots may exist in various types depending on their purposes, robots may have different structures for different purposes, and a program suitable for a corresponding purpose may be installed in the robot.

For example, robots providing at least one service among delivery, logistics work, guidance, interpretation, parking assistance, security, crime prevention, guard, policing, cleaning, quarantine, disinfection, laundry, beverage preparation, food preparation, serving, firefighting, medical support, and/or entertainment services may be deployed in the building 1000. The services provided by robots may vary beyond the examples listed above.

Meanwhile, the cloud server 20 may assign appropriate tasks to the robots in consideration of the purpose of each of the robots, and may perform control of the robots so that the assigned tasks are carried out.

At least some (e.g., at least a portion) of the robots described in the present disclosure may travel or perform tasks under the control of the cloud server 20, and in this case, the amount of data processed in the robot itself to perform travel or tasks may be reduced or minimized. In the present disclosure, such a robot may be referred to as a “brainless robot.” Such a brainless robot may depend on at least some control by the cloud server 20 for performing actions such as traveling, carrying out tasks, charging, standby, and/or cleaning within the building 1000.

However, in the present specification, brainless robots are not separately named, and all robots are consistently referred to as “robots”.

Meanwhile, some example embodiments of the present disclosure provide methods and/or systems for assigning elevators to people and/or robots and controlling robots for elevator boarding, in order to reduce or minimize inconvenience to users and provide an environment in which people and robots can safely and efficiently coexist within a building where people and robots coexist.

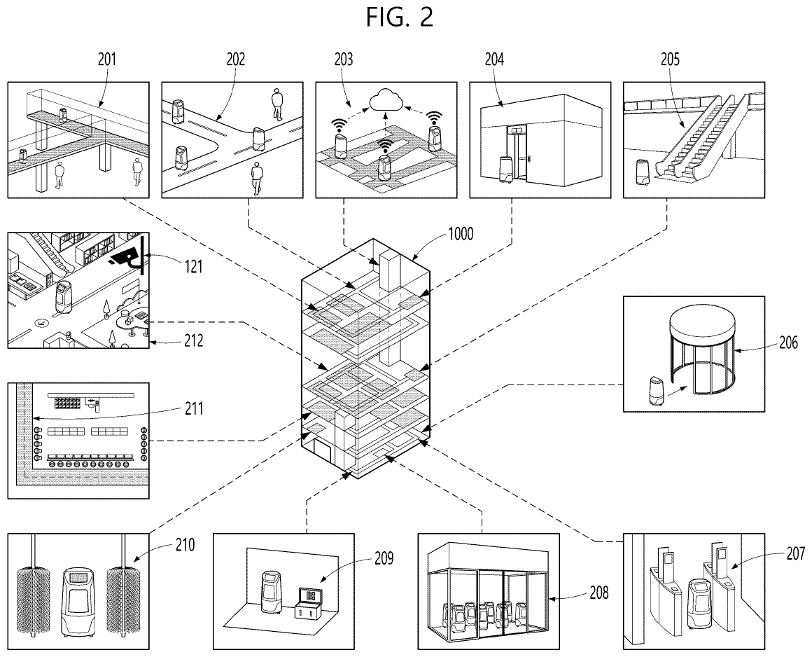

As described above, the building 1000 according to some example embodiments of the present disclosure may be equipped with various facility infrastructure used by robots, and as shown in FIGS. 2, 3, and 4, the facility infrastructure may be disposed within the building 1000 and, through linkage with (e.g., through communications between) the building 1000 and the cloud server 20, may support movement (or travel) of the robot or provide various functions to the robot.

For example, the facility infrastructure may include a transportation device, such as an elevator 204, to support movement of the robot within the building, and the robot may use the elevator 204 to move in a vertical direction (movement between different floors).

The elevator 204 may be used by both robots and people, and people may experience inconvenience or time delays when boarding and alighting the elevator due to the robots. Accordingly, based on the demand for elevator use by people and robots, some example embodiments of the present disclosure propose methods and/or systems for comprehensively managing the number of elevators assigned (or allocated) to people and robots, the elevator boarding method (e.g., robot boarding alone, people and robots boarding together, people boarding alone), and/or the number of robots boarding a single elevator unit.

Hereinafter, methods and/or systems for assigning elevators and controlling robots will be described together with the accompanying drawings.

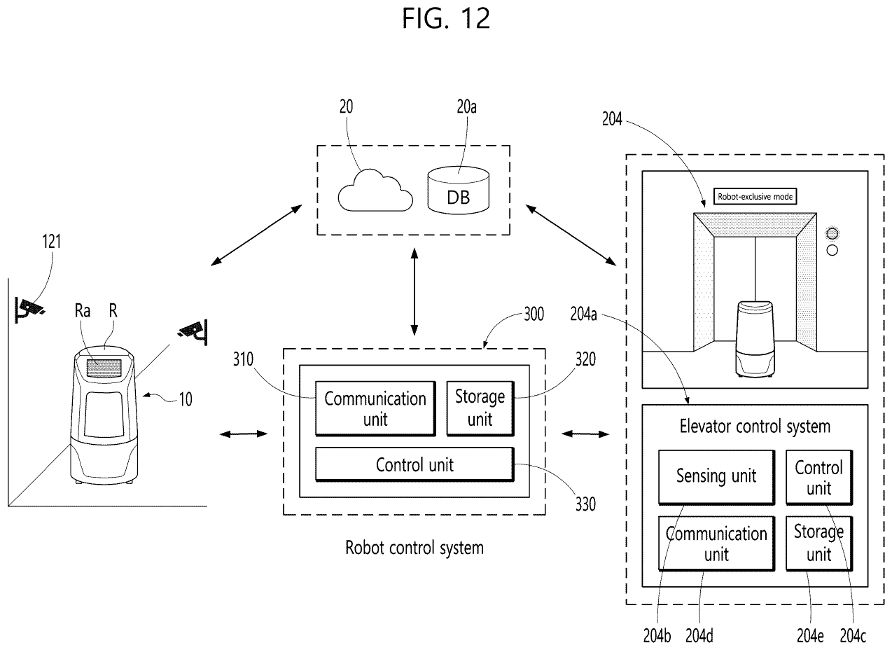

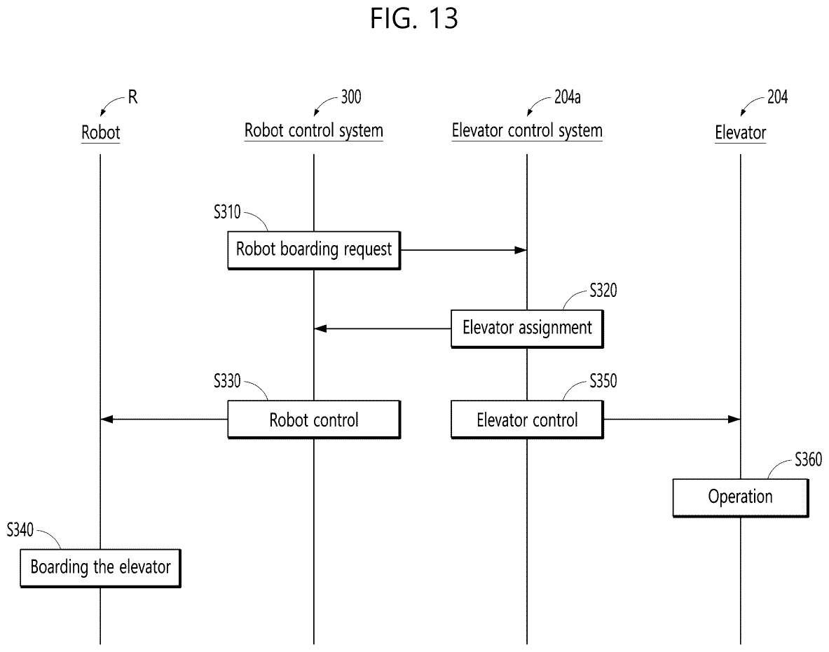

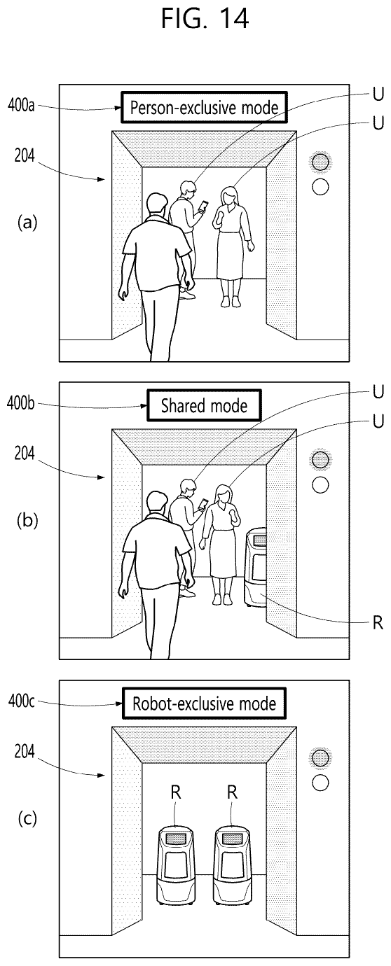

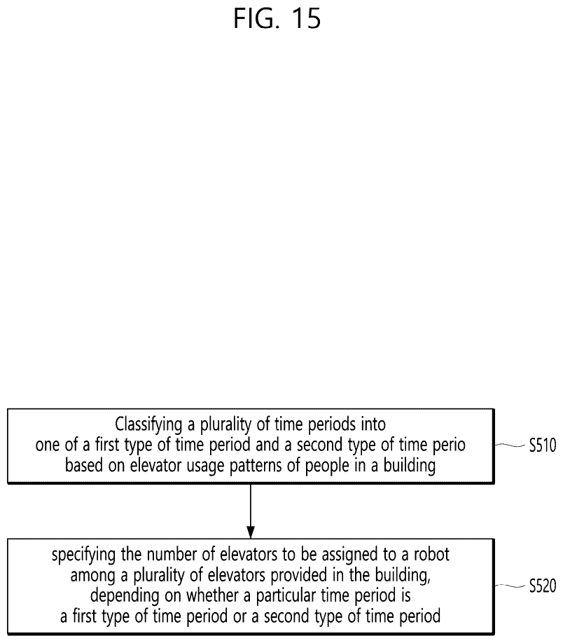

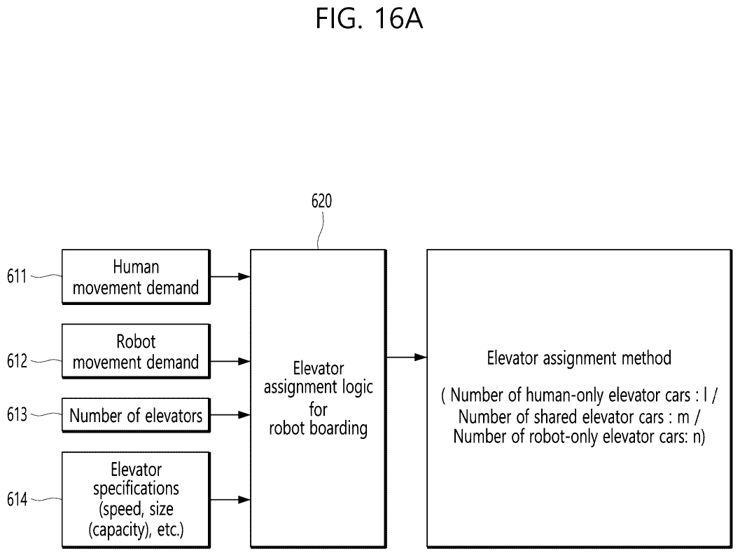

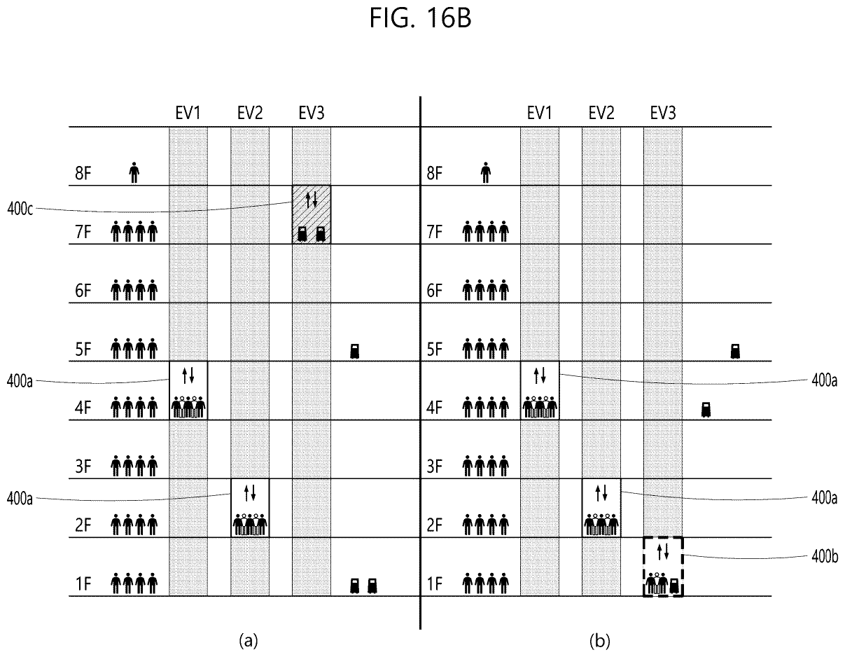

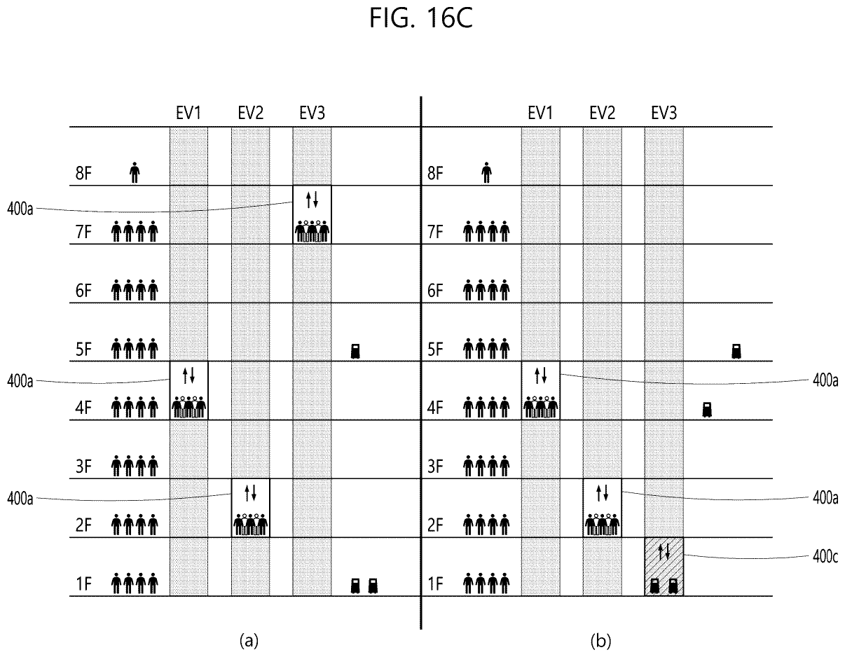

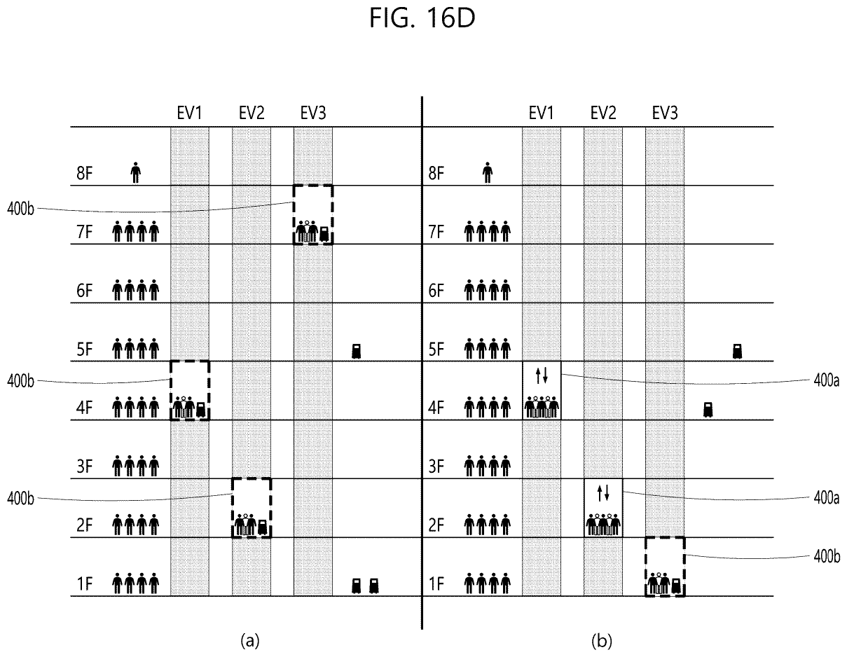

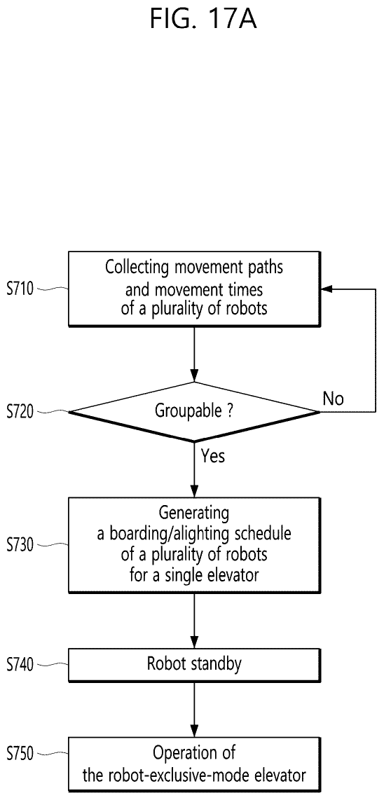

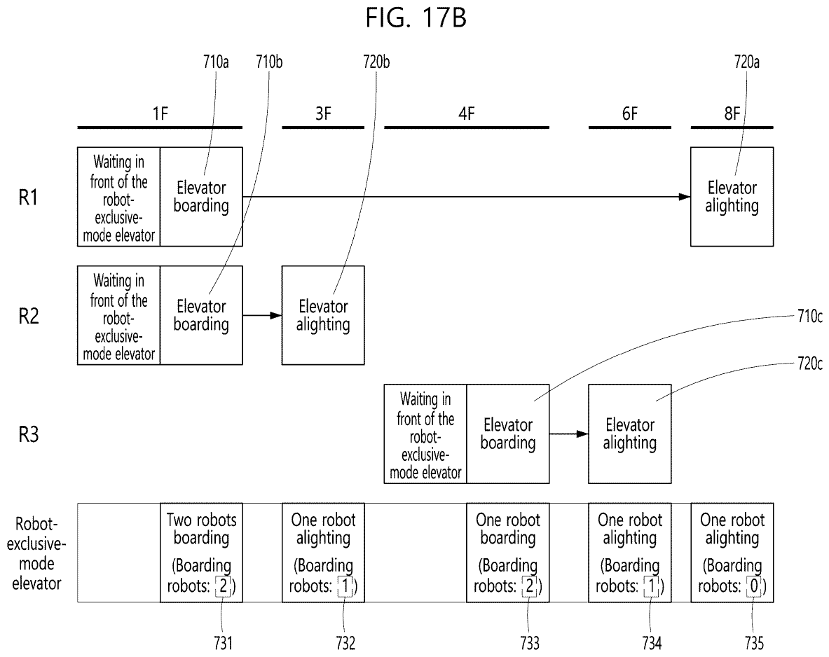

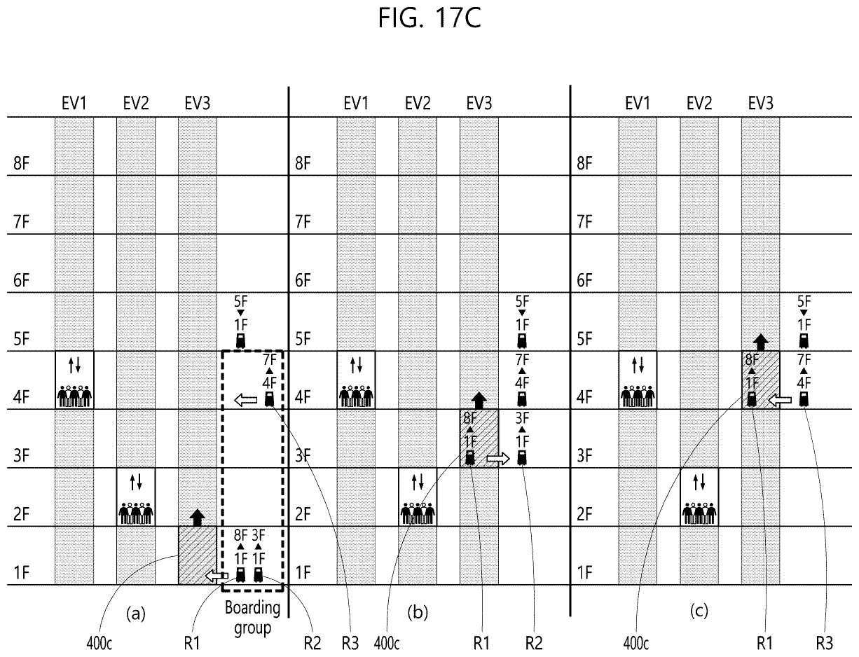

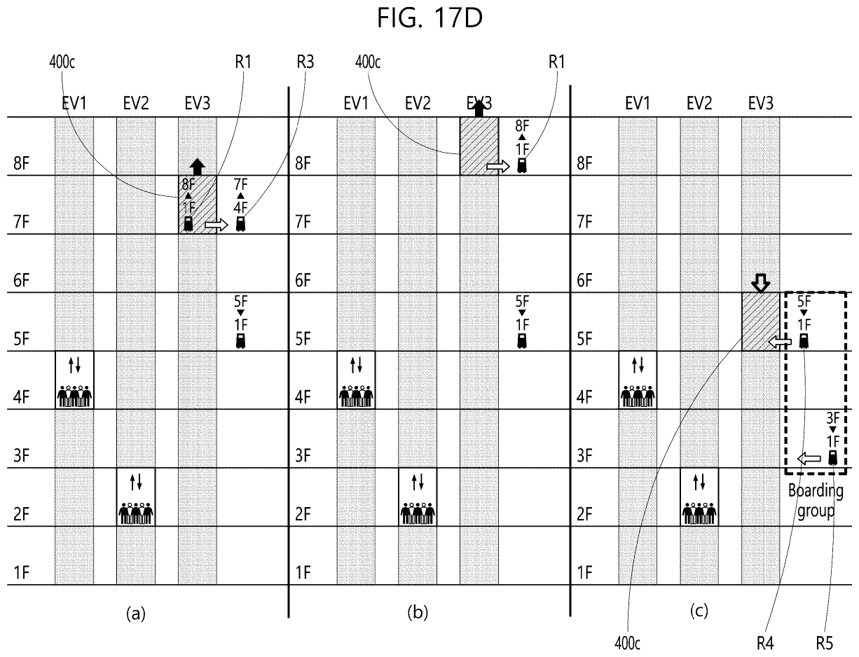

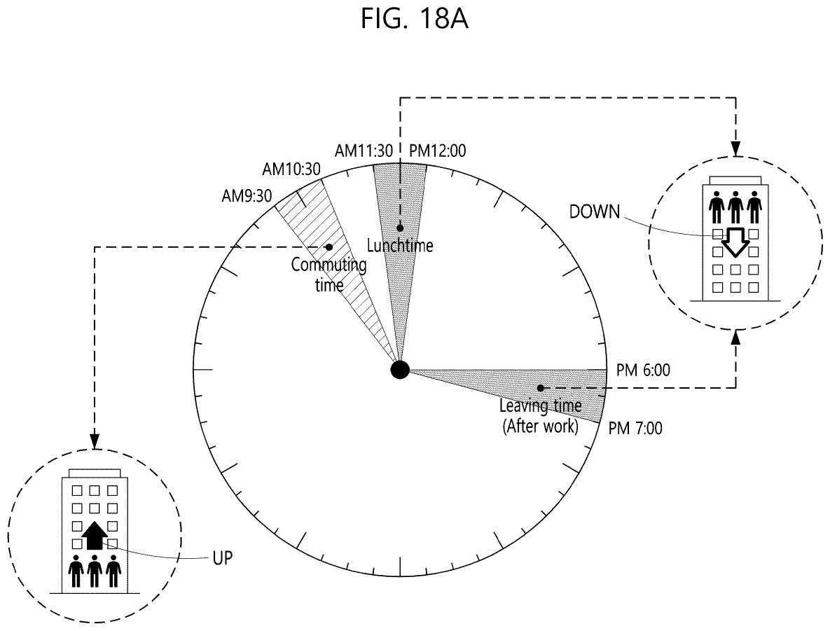

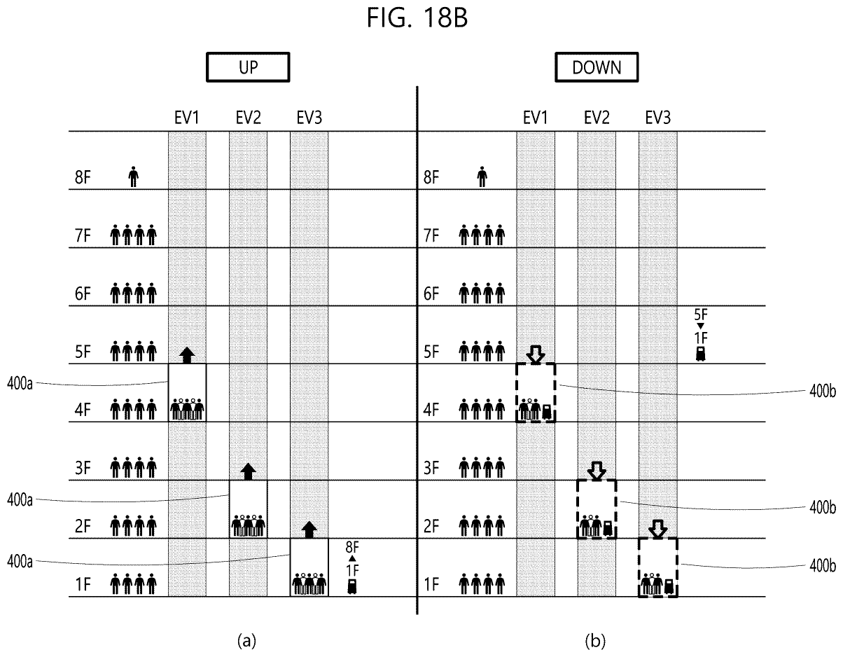

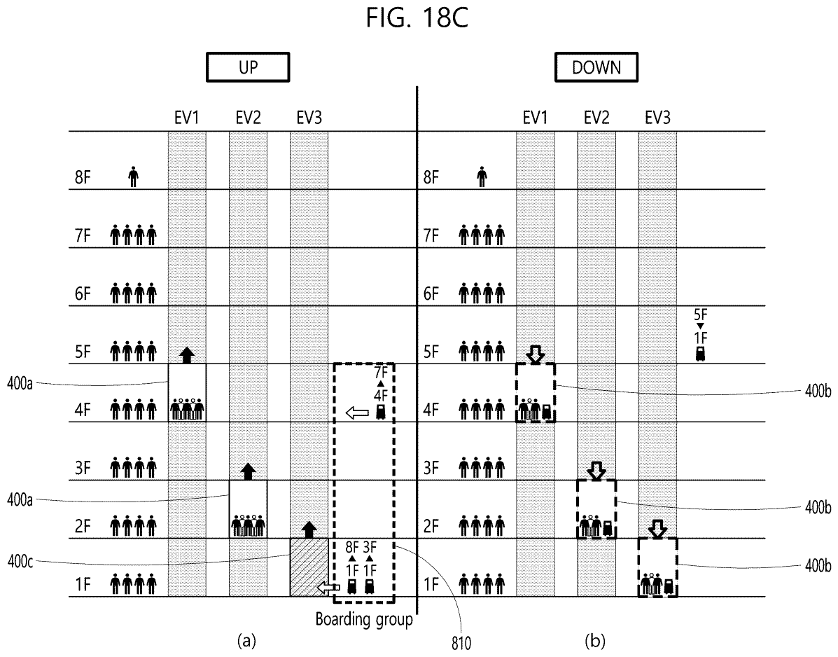

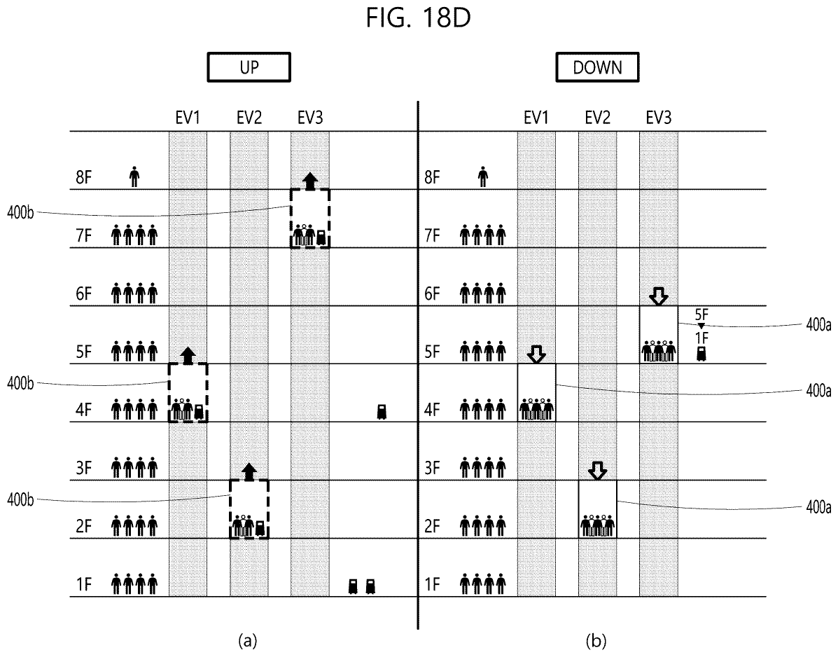

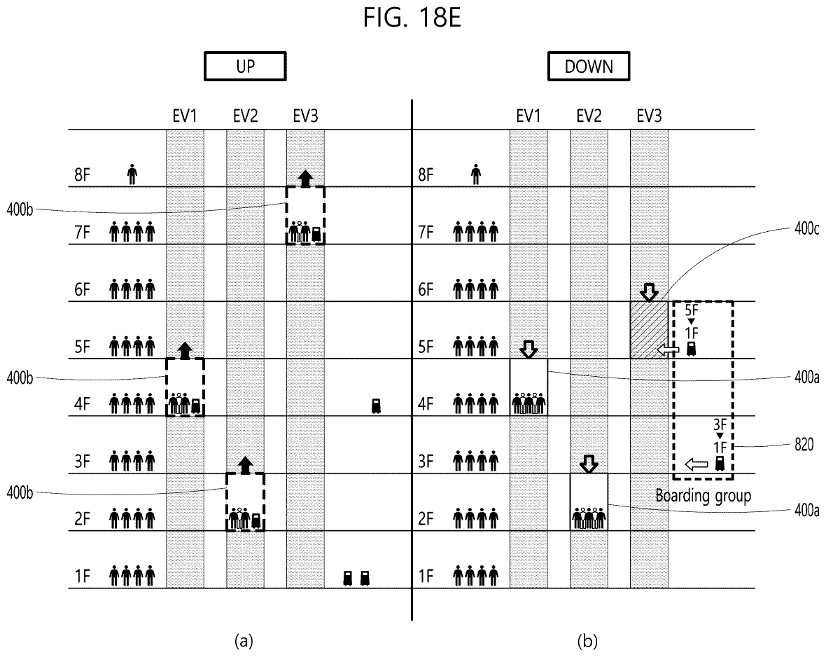

FIG. 12 is a conceptual diagram for explaining a system for assigning elevators and controlling robots for elevator boarding in an environment where people and robots coexist. FIG. 13 is a flowchart for explaining the linkage between robots and elevators in an example embodiment of the present disclosure, FIG. 14 is a conceptual diagram for explaining operation modes of elevators in an environment where people and robots coexist, FIG. 15 is a flowchart for explaining a method for assigning elevators and controlling robots for elevator boarding in an environment where people and robots coexist, FIGS. 16A, 16B, 16C, and 16D are conceptual diagrams for explaining a method for assigning elevators in an environment where people and robots coexist, FIGS. 17A, 17B, 17C, and 17D are conceptual diagrams for explaining a method for assigning elevators based on a robot group and controlling the robot group for elevator boarding, and FIGS. 18A, 18B, 18C, 18D, and 18E are conceptual diagrams for explaining a method for assigning elevators according to the travel direction of people and controlling robots for elevator boarding in an environment where people and robots coexist.

As shown in FIG. 12, the cloud server 20 according to an example embodiment of the present disclosure may perform integrated management of the robot R and elevators in the building 1000 where people and the robot R coexist, through communication with at least one of the robot R, the robot control system 300, or the elevator control system 204a. Accordingly, in the present disclosure, the cloud server 20 may also be referred to as a robot-elevator integrated management system.

In the present disclosure, the robot control system 300 and the elevator control system 204a may be understood as systems controlled by the cloud server 20. At least some of the data processing of the robot control system 300 and/or the data processing of the elevator control system 204a described below may be understood as being performed in the cloud server 20 or under the control of the cloud server 20.

Meanwhile, the robot control system 300 according to some example embodiments of the present disclosure may be a system that performs integrated control of the robot R traveling in the space 10 within the building, and in the present disclosure, the term “robot control system” may be variously changed to terms such as server, cloud server 20, cloud robot system, cloud system, cloud robot control system, cloud control system, robot system, and the like.

The robot control system 300 according to some example embodiments of the present disclosure may perform appropriate control so that the robot R uses the elevator 204 through communication with the elevator control system 204a.

The elevator control system 204a may include at least one of a sensing unit 204b configured to sense various information related to the elevator 204 or a control unit 204c configured to perform control of the elevator 204. Such an elevator control system 204a may perform control of the elevator 204 so that the robot R uses the elevator 204. For example, the elevator control system 204a may control the elevator 204 to stop at the floor where the robot R is located so that the robot R boards the elevator 204, through communication with the robot control system 300.

At least some of the elevator control system 204a may be controlled by the cloud server 20 or by the control unit (designated by reference numeral 150 in FIG. 4) of the building 1000. In this case, the term “elevator control system 204a” may be replaced and expressed by the term “cloud server 20” or the term “control unit 150 of the building 1000”.

Meanwhile, the robot control system 300 according to some example embodiments of the present disclosure may be configured to include at least one of a communication unit 310, a storage unit 320, or a control unit 330.

The communication unit 310 may be configured to communicate with at least one of the robot R or the elevator control system 204a, as shown. The communication unit 310 may control the robot R to move through the space 10 within the building 1000 using the elevator, through communication with at least one of the robot R or the elevator control system 204a.

The communication unit 310 may support various communication methods according to the communication standards of the device with which it communicates.

For example, the communication unit 310 may be configured to communicate with other devices (including robots and elevator control systems) located within the building 1000 using at least one of the following technologies: WLAN (Wireless LAN), Wi-Fi (Wireless-Fidelity), Wi-Fi (Wireless Fidelity) Direct, DLNA (Digital Living Network Alliance), WiBro (Wireless Broadband), WiMAX (World Interoperability for Microwave Access), HSDPA (High Speed Downlink Packet Access), HSUPA (High Speed Uplink Packet Access), LTE (Long Term Evolution), LTE-A (Long Term Evolution-Advanced), 5G (5th Generation Mobile Telecommunication), Bluetooth™, RFID (Radio Frequency Identification), IrDA (Infrared Data Association), UWB (Ultra-Wideband), ZigBee, NFC (Near Field Communication), Wi-Fi Direct, and Wireless USB (Wireless Universal Serial Bus).

Next, the storage unit 320 may be configured to store various information related to the present disclosure. In some example embodiments of the present disclosure, the storage unit 320 may be provided in the robot control system 300 itself. Alternatively, at least some of the storage unit 320 may be stored in a cloud server (or a database of the cloud server, 20a). That is, it may be understood that the storage unit 320 is a space in which information desired for controlling the robot according to some example embodiments of the present disclosure is stored, and there is no restriction on the physical space. Accordingly, hereinafter, the storage unit 320 and the external database 20a will not be separately distinguished and both will be referred to as the storage unit 320. In this case, the external database 20a may refer to “cloud storage”. Furthermore, the storage unit 320 may be configured to store not only information about the robot control system 300 but also various information related to the elevator control system 204a.

First, information about the robot R may be stored in the storage unit 320.

Information about the robot R may vary widely, and examples of information about the robot R may include: i) identification information for identifying the robot R deployed in the space 10 (e.g., serial number, TAG information, QR code information, etc.), ii) task information assigned to the robot R, iii) travel path information set for the robot R, iv) location information of the robot R, v) status information of the robot R (e.g., power status, presence of malfunction, battery status, etc.), and/or vi) image information received from a camera provided in the robot R.

Next, a map (or map information or node map) of the space 10 may be stored in the storage unit 320. Here, the map may consist of or include at least one of a two-dimensional map or a three-dimensional map. The map of the space 10 may refer to a map that can be utilized to determine the current location of the robot R or to set the travel path of the robot.

For example, in the robot control system 300 according to some example embodiments of the present disclosure, the location of the robot R may be determined based on an image received from the robot R or sensing information received from the robot R. To this end, the map of the space 10 stored in the storage unit 320 may be composed of data that enables location estimation based on images or sensing information.

In this case, the map of the space 10 may be a map created based on SLAM (Simultaneous Localization and Mapping) by at least one robot moving through the space 10 in advance.

Information about a plurality of elevators 204 located within the building 1000 (e.g., identification information, location information, and operation information of the elevators) may be stored in the storage unit 320.

Meanwhile, in addition to the types of information listed above, various information may be stored in the storage unit 320.

Next, the control unit (or controller) 330 may be configured to control the overall operation of the robot control system 300 related to the present disclosure.

The control unit 330 may process signals, data, information, and the like that are input or output through the components described above to control the robot R, or to provide or process appropriate information or functions for the user.

The control unit 330 may be configured to include a processor based on an artificial intelligence or deep learning algorithm. In addition, the control unit 330 may perform various controls for boarding, waiting, and alighting of the robot R with respect to the elevator 204.

For example, the control unit 330 may determine whether the robot R boards the elevator 204 based on the occupancy status of the accommodation space 10 of the elevator 204. In some example embodiments of the present disclosure, the determination of whether the robot R boards the elevator 204 may be performed by at least one of the robot R or the robot control system 300. When the robot control system 300 determines whether the robot R boards, the robot R may board the elevator 204 or give up boarding the elevator 204 based on a control command received from the robot control system 300. Accordingly, in the present disclosure, the robot control system 300 will be described as the main subject for convenience of explanation. However, the determination of whether the robot R boards, which is made in the robot control system 300, may be made independently by the robot (or the control unit of the robot).

Meanwhile, the elevator control system 204a may include at least one of a sensing unit 204b, a control unit 204c, a communication unit 204d, or a storage unit 204e.

The sensing unit 204b may be provided in the elevator 204 itself and may be configured to sense various information related to the elevator 204. For example, the sensing unit may include a camera (image sensor), a proximity sensor, an infrared sensor, a laser scanner (LiDAR sensor), an RGBD sensor, a geomagnetic sensor, an ultrasonic sensor, an inertial sensor, a UWB sensor, and the like.

The control unit 204c performs control for driving each of the plurality of elevators 204 disposed in the building 1000, and may perform appropriate control so that the robot R uses the facility through communication with the cloud server 20. For example, the elevator control system 204a may control the elevator 204 to stop at the floor where the robot R is located so that the robot R boards the elevator 204, through communication with the cloud server 20.

Furthermore, the control unit 204c may set the operation modes of the elevators disposed in the building 1000 (a person-exclusive mode operated for people, a shared mode operated for both people and the robot R, and a robot-exclusive mode operated for the robot R) by the control of the cloud server 20 or by the control unit 204c's own data processing.

The communication unit 204d may be configured to communicate with at least one of the cloud server 20, the robot control system 300, the robot R, or the elevator 204. For example, the communication unit 204d may receive an elevator boarding request (or riding request) of the robot R from the robot control system 300. In addition, the communication unit 204d may transmit a control command to the elevator 204 so that the robot R can board (or ride) the elevator 204.

The storage unit 204e may store various information related to elevator control. For example, there may exist: i) identification information for identifying the elevators disposed in the building 1000 (e.g., serial number, TAG information, QR code information, etc.), ii) information about the operation modes of the elevators, iii) robot information of the robot R that has boarded the elevator, iv) elevator operation information (e.g., location, travel direction, floor being moved to, etc.), v) elevator status information (e.g., power status, presence of malfunction, battery status, etc.), and/or vi) image information received from a camera provided in the elevator and image information received from a camera provided in the robot R.

Meanwhile, as shown in FIG. 13, when the robot R wishes to or needs to board the elevator 204, the robot control system 300 may request the elevator control system 204a to board the robot R (S310).

For example, assume that the task of the robot R located on the first floor is a delivery task to deliver an object to the 20th floor. The robot control system 300 may determine that the robot R wishes to or needs to board the elevator 204 to move to the 20th floor in order to perform the delivery task, and may request the elevator control system 204a to board the robot R.

The elevator control system 204a may assign one of a plurality of elevators provided in the building 1000 to the robot R in response to the boarding request of the robot (S320).

In the present disclosure, “elevator assignment” may be understood as a process of linking the elevator 204 and the robot R to each other so that the robot R can move using the elevator 204 from the floor corresponding to the current location of the robot R to the floor corresponding to the destination.

The robot control system 300 may perform control of the robot R so that the robot R uses the elevator 204, based on receiving assignment information from the elevator control system 204a (S330).

The assignment information may include various information related to elevator assignment. For example, the assignment information may include at least one of identification information of the assigned elevator 204, location information, operation information (e.g., floors at which the elevator stops), operation mode information (robot-exclusive mode or shared mode), or time information at which the assigned elevator 204 stops at the floor corresponding to the current location of the robot R.

The robot R may move through the space 10 within the building 1000 under the control of the robot control system 300. The robot R may move from its current location to the area (or zone) where the elevator 204 is located, and then board the elevator 204 to move to another floor (S340).

The elevator control system 204a may perform control of the corresponding elevator 204 based on having assigned the elevator 204 to the robot R (S350). For example, the elevator control system 204a may cause the elevator 204 to stop at the floor corresponding to the current location of the robot R and open the door of the elevator 204. The elevator control system 204a may monitor the boarding or alighting of the robot R when the door of the elevator 204 is open. The elevator control system 204a may maintain the door in an open state until the boarding or alighting of the robot R is completed. And the elevator control system 204a may control the door to close and move (operate) to another floor when the boarding and alighting of the robot R is completed. In this manner, the elevator 204 may be operated under the control of the elevator control system 204a (S360).

The elevator control system 204a may monitor the completion of boarding or alighting of the robot R through communication with the robot control system 300. For example, the elevator control system 204a may monitor the completion of boarding and alighting of the robot R based on identification information of the robot R received from the robot control system 300. As another example, the elevator control system 204a may monitor the completion of boarding and alighting of the robot R based on receiving location information from the robot control system 300 indicating that the robot R is located inside/outside the elevator 204.

Meanwhile, the elevator is a bottleneck section of movement within the building 1000, and the use of the elevator by the robot R may cause inconvenience to people. Accordingly, the present disclosure proposes an elevator assignment policy that flexibly assigns at least some of the plurality of elevators to the robot, so as to reduce or minimize inconvenience to people in the use of the elevator by the robot R and at the same time enable efficient operation of the elevator use by the robot R.

The elevator assignment policy described in the present disclosure may be understood as a logic, algorithm, or rule for specifying an elevator available for the robot (or people) among the plurality of elevators provided in the building.

In some example embodiments of the present disclosure, the operation mode of each of the plurality of elevators provided in the building 1000 may be determined in accordance with the elevator assignment policy. In some example embodiments of the present disclosure, the operation mode may include a “person-exclusive mode”, a “shared mode”, and a “robot-exclusive mode”, depending on who among the robot R and the people U is the restricted subject whose elevator boarding is restricted and who is the priority subject whose elevator boarding is prioritized.

As shown in the top figure of FIG. 14, among the plurality of operation modes, the “person-exclusive mode 400a” may be understood as an elevator operation mode that restricts boarding by the robot R and prioritizes boarding by the people U. An elevator operated in the person-exclusive mode may be referred to and described as a person-exclusive elevator.

As shown in the middle figure of FIG. 14, among the plurality of operation modes, the “shared mode 400b” is a mode of operating the elevator 204 so that both the robot R and the people U can use it without restricting boarding by the people U, and may be referred to as “shared mode” or “common mode”. In the present disclosure, an elevator 204 operated in the shared mode may be referred to and described as a shared elevator.

As shown in the bottom figure of FIG. 14, among the plurality of operation modes, the “robot-exclusive mode 400c” is an elevator operation mode that restricts boarding by the people U and prioritizes boarding by the robot R, and may also be referred to as “robot mode”. In the present disclosure, an elevator operated in the robot-exclusive mode may be referred to and described as a robot-exclusive elevator.

In some example embodiments of the present disclosure, the elevator may be assigned to the robot R by setting the operation mode of the elevator to the robot-exclusive mode or the shared mode. In addition, in the present disclosure, the elevator may be assigned to the people by setting the operation mode of the elevator to the person-exclusive mode or the shared mode.

In some example embodiments of the present disclosure, based on occurrence of an elevator boarding event for the robot R traveling in the building 1000, an elevator assigned to the robot R (an elevator operated in the shared mode or the robot-exclusive mode) may be allocated as the boarding target elevator of the robot R, and control of the robot R may be performed so that the robot R uses the boarding target elevator.

In some example embodiments of the present disclosure, at least one of the following data processing operations may be performed by the cloud server 20 or the elevator control system 204a: i) setting the elevator assignment policy, ii) setting the operation mode of the elevator in accordance with the elevator assignment policy, and/or iii) allocating an elevator operated in one of the robot-exclusive mode or the shared mode as the boarding target elevator of the robot R. In addition, in some example embodiments of the present disclosure, robot control for using the boarding target elevator may be performed by the cloud server 20 or the robot control system 300.

Accordingly, in the present disclosure, for convenience of explanation, the cloud server 20, the elevator control system 204a, and the robot control system 300 will not be distinguished, and the data processing performed in the present disclosure will be described based on the “cloud server.” However, the data processing performed by the cloud server 20 may be performed by at least one of the elevator control system 204a or the robot control system 300, and in this case, it may also be understood as being performed under the control of the cloud server 20. In addition, in the present disclosure, the cloud server may also be referred to as an “elevator assignment system,” and the elevator assignment system may perform data processing using the respective components included in the elevator control system 204a and the robot control system 300.

Hereinafter, a method of setting the operation mode of the elevator based on the elevator assignment policy and controlling the elevator boarding of the robot R will be described in more detail.

In some example embodiments of the present disclosure, a process of classifying a plurality of time periods into one of a first type of time period or a second type of time period based on elevator usage patterns of people in the building may be performed (S510, see FIG. 15).

The cloud server 20 may classify a plurality of time periods into one of a first type of time period in which elevator usage by people increases (also referred to as a “peak time period”) or a second type of time period in which elevator usage is average (also referred to as a “general time period”), based on elevator usage patterns of people in accordance with the elevator assignment policy.

The cloud server 20 may collect information desired for the elevator assignment policy. The information desired for the elevator assignment policy may vary. For example, as shown in FIG. 16A, the cloud server 20 may collect at least one of people movement demand information 611, robot movement demand information 612, the number of elevators provided in the building 1000, 613, or elevator specification information (e.g., speed, maximum number of passengers, weight limit, floors served, etc., 614).

The people movement demand information 611 may vary. For example, the people movement demand information 611 may include at least one of i) the number of users of the building 1000 (e.g., number of workers), ii) off-work time, iii) lunch time, iv) elevator usage history information of people (e.g., usage time, travel direction, departure floor, arrival floor), v) elevator call count information, vi) image information capturing people using the elevator in the elevator accommodation space 10 and surrounding space, or vii) elevator inconvenience complaint information of people, and may be obtained based thereon.

The robot movement demand information 612 may include at least one of i) the number of robots R traveling in the building 1000, ii) elevator usage history information of the robot (e.g., usage time, travel direction, departure floor, arrival floor), or iii) tasks assigned to the robot using the elevator (e.g., delivery service, cleaning service, charging, etc.).

As shown in FIG. 16A, the cloud server 20 may set an elevator assignment policy (logic, 620) for robot boarding using the collected information 611 to 614. For example, the cloud server 20 may specify the number of elevators to be assigned to each of the people and each of the robots R, based on the elevator assignment policy 620. For example, the cloud server 20 may specify the number of elevators operated in the person-exclusive mode as “l”, the number of elevators operated in the shared mode as “m”, and the number of elevators operated in the robot-exclusive mode as “n”. In some example embodiments of the present disclosure, the operation modes of the elevators may be set based on the number of elevators per operation mode determined in accordance with the elevator assignment policy. Such an elevator assignment policy 620 is stored in the database 20a, and the cloud server 20 may update the elevator assignment policy 620 based on the collected information 611 to 614.

Meanwhile, in some example embodiments of the present disclosure, the elevator assignment policy may be determined based on elevator movement patterns of people for each of a plurality of time periods. The plurality of time periods may be set in various ways. For example, time periods may be set in units of “5 minutes”, “10 minutes”, or “30 minutes”.

The cloud server 20 may analyze elevator usage patterns of people for each of a plurality of time periods (e.g., elevator usage volume (average usage volume), elevator travel direction (e.g., average movement volume in the upward direction, average movement volume in the downward direction), departure floor, arrival floor, etc.) using the collected information in accordance with the elevator assignment policy.

The cloud server 20 may specify, as a peak time period, a time period in which elevator usage by people increases based on elevator usage patterns of people (e.g., a time period in which the elevator usage volume per time period unit exceeds a desired (or alternatively, preset) criterion. The cloud server 20 may specify time periods other than the peak time period as general time periods.

For example, as shown in FIG. 18A, the cloud server 20 may specify at least one of the commute time (e.g., AM 9:30 to AM 10:30), lunch time (e.g., AM 11:30 to PM 12:30), or off-work time (e.g., PM 6:00 to PM 7:00) as a peak time period, based on elevator usage by people surging (or the elevator usage volume per time unit satisfying a desired (or alternatively, preset) criterion during the commute time, lunch time, and off-work time. The remaining time periods may be specified as general time periods.

In some example embodiments of the present disclosure, a process of specifying a number of elevators to be assigned to the robot among a plurality of elevators provided in the building, depending on whether a particular time period is the first type of time period or the second type of time period, may be performed (S520, see FIG. 15).

The cloud server 20 may assign elevators differently for the peak time period (first type of time period) and the general time period (second type of time period) in accordance with the elevator assignment policy.

The cloud server 20 may prioritize elevator assignments for people during the peak time period, and may flexibly allocate elevators to the robot R as desired.

The cloud server 20 may assign elevators in the peak time period such that the number of elevators assigned to people is greater than the number of elevators assigned to the robot R.

For example, as shown in (a) of FIG. 16B, the cloud server 20 may, in the peak time period, assign some specific one (e.g., any one) of the plurality of elevators EV1, EV2, EV3, namely elevator EV3, to the robot R, and assign the remaining elevators EV1, EV2 to people. More specifically, the cloud server 20 may set a specific elevator EV3 among the plurality of elevators EV1, EV2, EV3 to the robot-exclusive mode 400c, and set the remaining elevators EV1, EV2 to the person-exclusive mode 400a.

In this case, the cloud server 20 may switch the operation mode of a specific elevator EV3 in the peak time period so that the specific elevator EV3 is alternately set to the robot-exclusive mode and the shared mode, based on the real-time elevator usage demand of the robot R. As shown in (b) of FIG. 16B, the cloud server 20 may set the specific elevator EV3 to the shared mode 400b so that people and the robot R can use the specific elevator EV3 together, when the elevator usage demand (e.g., usage volume) of the robot R is low (or below a certain criterion). The cloud server 20 may set the specific elevator EV3 back to the robot-exclusive mode 400c so that the robot R uses the specific elevator EV3 in priority, when the elevator usage demand (e.g., usage volume) of the robot R is high (or equal to or above a certain criterion).

As another example, as shown in (a) of FIG. 16C, the cloud server 20 may set all of the plurality of elevators EV1, EV2, EV3 to the person-exclusive mode 400a in the peak time period, thereby assigning all of the plurality of elevators EV1, EV2, EV3 to people. The cloud server 20 may monitor the occurrence of an elevator assignment event for the robot R (e.g., robot grouping) in a state where all of the plurality of elevators EV1, EV2, EV3 are set to the person-exclusive mode 400a (or are assigned to people). As shown in (b) of FIG. 16C, the cloud server 20 may temporarily switch the specific elevator EV3 from the person-exclusive mode 400a to the robot-exclusive mode 400c based on the occurrence of an elevator assignment event for the robot R. A detailed description of the elevator assignment event for the robot R will be provided later.

Meanwhile, the cloud server 20 may allocate all of the plurality of elevators to both people and the robot R so that both people and the robot R can use all of the plurality of elevators in the general time period.

As shown in (a) of FIG. 16D, the cloud server 20 may set the plurality of elevators EV1, EV2, EV3 to the “shared mode 400b” in the general time period. In the general time period, people and the robot R may use all of the elevators EV1, EV2, EV3 together.

The cloud server 20 may monitor the elevator usage demand of the robot R in the general time period, and as shown in (b) of FIG. 16D, may switch some of the elevators EV1, EV2 of the plurality of elevators EV1, EV2, EV3 to the person-exclusive mode 400a for operation based on the monitoring result.

That is, in the general time period, the cloud server 20 may primarily set the plurality of elevators EV1, EV2, EV3 to the shared mode 400b, and secondarily switch some of the elevators EV1, EV2 to the shared mode 400b or the person-exclusive mode 400a according to the real-time elevator usage demand of the robot R, thereby reducing the number of elevators available to the robot R.

Meanwhile, the cloud server 20 may control the operation of the elevator operated in the robot-exclusive mode based on a robot group consisting of a plurality of robots R.

As described above, in the peak time period, a specific elevator (e.g., one elevator, EV3) among the plurality of elevators EV1, EV2, EV3 may be operated in the robot-exclusive mode. The cloud server 20 may efficiently operate the specific elevator EV3 by controlling the operation of the one specific elevator EV3 based on the robot group.

As shown in FIG. 17A, the cloud server 20 may collect real-time movement demand, including movement paths and/or movement times, for a plurality of robots R (S710).

The cloud server 20 may collect information on at least one of the vertical movement path of the robot R in which the elevator boarding event has occurred (the floor currently located at the elevator boarding floor or riding floor), the destination floor (the elevator alighting floor), the travel time from the current location of the robot R to the waiting area of the specific elevator EV3 (or the scheduled time for being positioned at the waiting area), or the scheduled task completion time.

The cloud server 20 may perform robot grouping for boarding the specific elevator operated in the robot-exclusive mode based on the collected information.

The cloud server 20 may determine whether a boarding group, including the corresponding robots R, can be identified, if the number of robots R in which the boarding event in the same vertical direction (upward direction or downward direction) has occurred is equal to or greater than a desired (or alternatively, reference or preset) number (e.g., “2”) (S720, see FIG. 17A).

For example, as shown in FIG. 17B, assume that the vertical movement path of the first robot R1 includes boarding the elevator at the first floor 710a and alighting from the elevator at the eighth floor 720a, and the vertical movement path of the second robot R2 includes boarding the elevator at the first floor 710b and alighting from the elevator at the third floor 720b. The cloud server 20 may identify a boarding group, including the first robot R1 and the second robot R2, based on the boarding event in the upward direction occurring for the “2” robots, the first robot R1 and the second robot R2.

Here, the “desired (or alternatively, reference or preset) number” may be set in various ways. For example, the cloud server 20 may set the number serving as the criterion for the boarding group by considering at least one of the travel direction of the elevator, the maximum number of robots that can board the accommodation space 10 of the elevator (or the maximum number of boarding robots set for the elevator), the elevator usage demand of the robots R, or the number of elevators assigned to the robot R.

Furthermore, the cloud server 20 may identify a boarding group, including a plurality of robots R1, R2, R3, such that a number of robots R equal to or less than the desired (or alternatively, reference or preset) number (e.g., “2”) board the specific elevator, based on the vertical movement paths of the plurality of robots R1, R2, R3 exceeding the desired (or alternatively, preset) number (e.g., “2”).

The cloud server 20 may identify all of the plurality of robots R1, R2, R3 as the same boarding group, even if the number of the plurality of robots R1, R2, R3 exceeds the desired (or alternatively, reference or preset) number (e.g., “2”), if the number of overlapping vertical movement paths among the vertical movement paths of the plurality of robots R1, R2, R3 is equal to or less than the desired (or alternatively, reference or preset) number (e.g., “2”).

For example, as shown in FIG. 17B, assume that the vertical movement path of the third robot R3 includes boarding the elevator at the fourth floor 710c and alighting from the elevator at the sixth floor 720c. If, in a state where the first robot R1 and the second robot R2 have boarded the elevator at the first floor, the second robot R2 alights from the elevator at the third floor and the third robot R3 boards the elevator at the fourth floor sequentially, no more than “2” robots will continue to be aboard the elevator. More specifically, when the first robot R1 and the second robot R2 board the elevator at the first floor, the number of boarding robots aboard the elevator is “2” (731). The number of robots aboard the elevator becomes “1” (732) due to the alighting of the second robot R2 at the third floor, and when the third robot R3 boards at the fourth floor, the number of robots R aboard the elevator may become “2” (733) again. Thereafter, when the third robot R3 alights at the seventh floor and the first robot R1 alights at the eighth floor, the number of boarding robots changes to “1” (734) and “0” (735).

In this manner, the cloud server 20 may identify the plurality of robots R1, R2, R3 as the same boarding group even if the number of the plurality of robots R1, R2, R3 exceeds the desired (or alternatively, reference or preset) number, if the number of robots aboard the elevator is maintained at or below the desired (or alternatively, reference or preset) number (e.g., “2”) based on the vertical movement paths of the plurality of robots R1, R2, R3.

Furthermore, the cloud server 20 may identify the boarding group by further considering the travel time from the current location of the plurality of robots R1, R2, R3 to the elevator waiting area (or the scheduled time for being positioned at the waiting area). The cloud server 20 may identify the corresponding robots R as the same group based on the number of robots capable of moving to the elevator waiting area within the reference unit time being equal to or greater than the desired (or alternatively, reference or preset) number.

For example, assume that the travel times of the first robot R1, the second robot R2, and the third robot R3 to the waiting area are “30 seconds”, “1 minute”, and “5 minutes”, respectively. The cloud server 20 may group the first robot R1 and the second robot R2, which are capable of moving to the waiting area within the reference unit time (e.g., “1 minute”), into the same boarding group, even if the vertical movement paths of the first robot R1, the second robot R2, and the third robot R3 do not overlap.

Here, the reference unit time may be set in various ways. The cloud server 20 may set the reference unit time serving as the criterion for boarding group grouping based on at least one of an operation speed of the specific elevator operated in the robot-exclusive mode, a round-trip operation time, elevator usage demand of the robot R (or elevator usage patterns of the robots in the peak time period), elevator usage demand of people (or elevator usage patterns of people in the peak time period), or the number of elevators assigned to the robot R.

For example, assume that the round-trip time for an elevator to travel from the lowest floor to the highest floor is “1 minute”. The cloud server 20 may set the reference unit time to “1 minute”. As another example, the cloud server 20 may extend the reference unit time to “5 minutes” if the number of elevators assigned to the robot R is small and the elevator usage demand of the robot R is high.

As yet another example, if there is a robot R waiting longer than the reference unit time in a state where the reference unit time is set to “15 minutes”, the cloud server 20 may shorten the reference unit time or assign a boarding target elevator to the corresponding robot R.

Furthermore, the cloud server 20 may identify the boarding group by further considering at least one of an operation time (or operation speed) of the elevator or a boarding and alighting time desired for the robots (desired boarding time and desired alighting time).

The cloud server 20 may include the third robot R3 in the same boarding group as the first robot R1 and the second robot R2, if the third robot R3 is capable of boarding the elevator without delay, even if the travel time of the third robot R3 to the waiting area exceeds the reference unit time (e.g., “1 minute”), based on the operation time (operation speed) of the elevator and the boarding and alighting time desired for the robots R.

The cloud server 20 may assign a specific elevator operated in the robot-exclusive mode to a plurality of robots R1, R2, R3 included in the boarding group, based on being identified in the boarding group. The cloud server 20 may control the movement of the plurality of robots R1, R2, R3 to the elevator waiting area so that the plurality of robots R1, R2, R3 board (or ride) the specific elevator.

Meanwhile, if boarding group grouping of the robots R is not possible, the cloud server 20 may continue to collect movement paths and movement times of the robots R in which the boarding event has occurred. On the other hand, if boarding group grouping of the robots R is possible, the cloud server 20 may generate a boarding and alighting schedule of a plurality of robots for a single elevator (S730, see FIG. 17A).

The cloud server 20 may generate an elevator operation schedule (or boarding and alighting schedule) including elevator boarding times and alighting times of the plurality of robots R1, R2, R3 included in a specific boarding group, based on the movement paths and movement times (or scheduled times for being positioned at the waiting area) of the plurality of robots R1, R2, R3. The cloud server 20 may move the plurality of robots R1, R2, R3 to the elevator waiting area and control the operation of the elevator (ascending, descending, and stopping) based on the operation schedule.

More specifically, the cloud server 20 may generate an operation schedule of the elevator so that the specific elevator operates for the boarding group in a state where all of the robots R1, R2, R3 included in the boarding group are positioned at the waiting area. The cloud server 20 may control the operation of the specific elevator according to the operation schedule.

For example, assume that the boarding group includes the first robot R1, the second robot R2, and the third robot R3, and the travel times of the first robot R1, the second robot R2, and the third robot R3 to the waiting area are “1 minute”, “2 minutes”, and “10 minutes”, respectively. The cloud server 20 may generate an operation schedule such that the elevator operates starting from “10 minutes” after all of the plurality of robots R1, R2, R3 are positioned at the waiting area.

Furthermore, the cloud server 20 may generate an operation schedule of the elevator such that, by further considering the operation speed of the elevator and the boarding and alighting time desired for the robots, a robot scheduled to board at a floor where the elevator stops is positioned at the waiting area when the elevator stops at the floor where the robots are located.

For example, assume that “3 minutes” are desired for the boarding and alighting of the first robot R1 and the second robot R2 and for the elevator to travel to the floor where the third robot R3 is located. The cloud server 20 may generate an operation schedule such that the elevator operates starting from “7 minutes” later, if it is determined that the third robot R3 can be positioned at the waiting area when the elevator stops at the floor where the third robot R3 is located, even if the elevator starts operating after “7 minutes”.

The cloud server 20 may control the operation of the elevator operated in the robot-exclusive mode based on the operation schedule.

As shown in (a) of FIG. 17C, the cloud server 20 may control the operation of the specific elevator EV3 operated in the robot-exclusive mode 400c for the first robot R1, the second robot R2, and the third robot R3 included in the same boarding group according to the operation schedule. The cloud server 20 may control the operation of the elevator to open the door in a state where the elevator is located at the departure floor (e.g., the first floor). The cloud server 20 may close the door of the elevator based on the completion of boarding of the first robot R1 and the second robot R2 scheduled to board at the departure floor (e.g., the first floor), and may control the operation of the elevator to the next destination floor (or stopping floor).

According to the operation schedule, the cloud server 20 may control the operation of the elevator and the travel of the robots such that the second robot R2 alights from the elevator at the next stopping floor (e.g., the third floor) (see (b) of FIG. 17C), and the third robot R3 boards the elevator at the subsequent stopping floor (e.g., the fourth floor) (see (c) of FIG. 17C).

Furthermore, as shown in (a) of FIG. 17D, according to the operation schedule, the cloud server 20 may control the operation of the elevator and the travel of the robots such that the third robot R3 alights at another stopping floor (e.g., the seventh floor), and as shown in (b) of FIG. 17D, the first robot R1 alights at the last stopping floor (e.g., the eighth floor).

In some example embodiments of the present disclosure, control of the robot may be performed by at least one of the cloud server 20 or the robot control system 300, and control of the elevator may be performed by at least one of the cloud server 20 or the elevator control system 204a. Therefore, the above-described robot control and elevator control may be performed through linkage between the robot control system 300 and the elevator control system 204a.

Furthermore, as shown in (c) of FIG. 17D, the cloud server 20 may identify a plurality of robots (R4 and R5) in which the boarding event in the downward direction has occurred as the same boarding group, and may control the operation of the elevator operated in the robot-exclusive mode 400c for the corresponding boarding group.

Meanwhile, as described above, the cloud server 20 may set all of the plurality of elevators EV1, EV2, EV3 to the person-exclusive mode 400a in the peak time period, thereby assigning all of the plurality of elevators EV1, EV2, EV3 to people (see (a) of FIG. 16C).

The cloud server 20 may monitor the occurrence of an elevator assignment event for the robot R in a state where all of the plurality of elevators EV1, EV2, EV3 are set to the person-exclusive mode 400a (or assigned to people).

In this case, the cloud server 20 may determine that an elevator assignment event for the robot R has occurred when a robot group, including a plurality of robots, is identified.

The cloud server 20 may switch at least one of the elevators set to the person-exclusive mode 400a to the robot-exclusive mode 400c, based on the robot group being identified. That is, the cloud server 20 may assign an elevator assigned to people to the robot R, based on the robot group being identified (see (b) of FIG. 16C).

The cloud server 20 may control the operation of the elevator switched to the robot-exclusive mode 400c for the vertical movement within the building 1000 of the plurality of robots included in the robot group. Because the elevator operation control is the same as described above, it will be omitted.

In some example embodiments of the present disclosure, an elevator may be assigned to at least one of people or the robot R based on the movement direction of people in the peak time period.

The cloud server 20 may identify the main movement direction of people in the peak time period based on information collected for setting an elevator assignment policy.

Here, the main movement direction of people is the primary movement direction (or average movement direction) of people using elevators in the peak time period, and the cloud server 20 may identify the main movement direction of people in the peak time period based on which direction people mainly move among the upward direction (or first direction, UP) of moving from a lower-floor space to an upper-floor space and the downward direction (or second direction, DOWN) of moving from an upper-floor space to a lower-floor space.

For example, the cloud server 20 may identify a direction as the main movement direction of people in the peak time period if movement in that particular direction satisfies a specific criterion (e.g., movement or traffic in the particular direction accounts for 70% or more of total movement or traffic) in the peak time period.

As shown in FIG. 18A, the cloud server 20 may identify the main movement direction of people in the commuting-to-work time period as the upward direction UP, based on movement in the upward direction UP satisfying a specific criterion in the peak time period corresponding to the commuting-to-work time (AM 9:30 to AM 10:30). On the other hand, the cloud server 20 may identify the main movement direction of people in the lunch time period or the commuting-from-work time period as the downward direction DOWN, based on movement in the downward direction DOWN satisfying a specific criterion in the peak time period corresponding to the lunch time (AM 11:30 to PM 12:30) or the commuting-from-work time (PM 6:00 to PM 7:00). Furthermore, although not illustrated, the cloud server 20 may identify that the movement of people occurs in both directions BOTH if neither the movement in the upward direction UP nor the movement in the downward direction DOWN satisfies the specific criterion in the peak time period.

The cloud server 20 may differently set the number of elevators assigned to the robot R for each elevator travel direction (upward direction/downward direction) based on the main movement direction of people in the peak time period. That is, the cloud server 20 may differently set the operation mode of elevators for each elevator travel direction.

First, as shown in (a) of FIG. 18B, in a peak time period in which the main movement direction of people is the upward direction UP (e.g., a commuting-to-work time period), the cloud server 20 may set the elevators EV1, EV2, EV3 operated in the upward direction UP to the person-exclusive mode 400a.

As shown in (a) of FIG. 18B, the cloud server 20 may set the elevators EV1, EV2, EV3 operated in the downward direction DOWN to the shared mode 400b to control the operation, even in the same peak time period.

That is, the cloud server 20 may differently set the operation mode of the elevators depending on the travel direction of the elevators in the peak time period in which the main movement direction of people is the upward direction UP (e.g., a commuting-to-work time period).

More specifically, the cloud server 20 may control even the same elevator to be operated in the person-exclusive mode 400a when the elevator is operated in the upward direction, so that people may use the elevator on a priority basis. On the other hand, the cloud server 20 may switch the operation mode from the person-exclusive mode 400a to the shared mode 400b when the elevator is operated in the downward direction, so that both people and the robot R may use the elevator.

The cloud server 20 may restrict the assignment of a boarding target elevator to the robot R if the boarding group is not identified, even when a boarding event of the robot R in the upward direction occurs in the peak time period in which the main movement direction of people is the upward direction UP.

In this case, the cloud server 20 may control the robot R to wait in the elevator waiting area until the boarding group in the upward direction is identified. In contrast, the cloud server 20 may assign any one of the elevators EV1, EV2, EV3 operated in the shared mode 400b to the robot R when a boarding event of the robot R in the downward direction occurs.

Meanwhile, the cloud server 20 may monitor the occurrence of an elevator assignment event in the upward direction for the robot R (e.g., identification of a robot group) in a state where all elevators in the upward direction are being operated in the person-exclusive mode 400a.

As a result of the monitoring, when an elevator assignment event in the upward direction for the robot R occurs (when a robot group is identified), the cloud server 20 may assign at least one EV3 of the elevators EV1, EV2, EV3 operated in the upward direction UP to the boarding group of the robot R.

As shown in (a) of FIG. 18C, the cloud server 20 may switch the operation mode of at least one EV3 of the elevators EV1, EV2, EV3 operated in the upward direction UP from the person-exclusive mode 400a to the robot-exclusive mode 400c when the boarding group 810 in the upward direction UP is identified. The cloud server 20 may assign the corresponding elevator EV3 to the boarding group 810.

In this case, as shown in (b) of FIG. 18C, the cloud server 20 may switch the operation mode of the corresponding elevator EV3 from the robot-exclusive mode 400c to the shared mode 400b, based on the elevator EV3 that has been switched to and operated in the robot-exclusive mode 400c being operated again in the downward direction DOWN.

In this way, in some example embodiments of the present disclosure, in a peak time period where the movement demand of people wishing to move in the upward direction is relatively high, elevators moving in the upward direction may be assigned to people, thereby providing an environment where people can use elevators without inconvenience. In some example embodiments of the present disclosure, in an environment where people can use elevators on a priority basis, situations where the robot R needs or wishes to move in the upward direction may be continuously monitored, and elevators may be flexibly assigned to the robot R.

On the other hand, the cloud server 20 may assign elevators moving in the downward direction to both the robot and people, even in the same peak time period, so that the robot R may vertically move within the building 1000 to provide services. First, as shown in (a) of FIG. 18D, in a peak time period in which the main movement direction of people is the downward direction DOWN (e.g., a lunch time or commuting-from-work time period), the cloud server 20 may set the elevators EV1, EV2, EV3 operated in the upward direction UP to the shared mode 400b. On the other hand, as shown in (a) of FIG. 18B, the cloud server 20 may set the elevators EV1, EV2, EV3 operated in the downward direction DOWN to the person-exclusive mode 400a to control the operation, even in the same peak time period.

More specifically, the cloud server 20 may control even the same elevator to be operated in the shared mode 400b when the elevator is operated in the upward direction, so that both people and the robot R may use the elevator. On the other hand, the cloud server 20 may switch the operation mode of the elevator from the shared mode 400b to the person-exclusive mode 400a when the elevator is operated in the downward direction, so that people's use of the elevator is prioritized.

Meanwhile, the cloud server 20 may assign any one of the elevators EV1, EV2, EV3 operated in the shared mode 400b to the robot R when a boarding event of the robot R in the upward direction occurs in the peak time period, in which the main movement direction of people is the downward direction DOWN.

In contrast, the cloud server 20 may restrict the assignment of a boarding target elevator to the robot R if the boarding group is not identified even when a boarding event of the robot R in the downward direction occurs.

In this case, the cloud server 20 may control the robot R to wait in the elevator waiting area until the boarding group in the downward direction is identified.

More specifically, the cloud server 20 may monitor the occurrence of an elevator assignment event in the downward direction for the robot R (e.g., identification of a robot group) in a state where all elevators in the downward direction are being operated in the person-exclusive mode 400a.

As a result of the monitoring, when an elevator assignment event in the downward direction for the robot R occurs (when a robot group is identified), the cloud server 20 may assign at least one EV3 of the elevators EV1, EV2, EV3 operated in the downward direction to the boarding group of the robot R.

As shown in (b) of FIG. 18E, the cloud server 20 may switch the operation mode of at least one EV3 of the elevators EV1, EV2, EV3 operated in the downward direction DOWN from the person-exclusive mode 400a to the robot-exclusive mode 400c when the boarding group 820 in the downward direction DOWN is identified. The cloud server 20 may assign the corresponding elevator EV3 to the boarding group 820.

In this case, as shown in (a) of FIG. 18E, the cloud server 20 may switch the operation mode of the corresponding elevator EV3 from the robot-exclusive mode 400c to the shared mode 400b, based on the elevator EV3 that has been switched to and operated in the robot-exclusive mode 400c being operated again in the upward direction UP.

In this way, in some example embodiments of the present disclosure, in a peak time period where the movement demand of people wishing to move in the downward direction is relatively high, elevators moving in the downward direction may be assigned to people, thereby providing an environment where people can use elevators without inconvenience. In some example embodiments of the present disclosure, in an environment where people can use elevators on a priority basis, situations where the robot R wishes to or needs to move in the downward direction may be continuously monitored, and elevators may be flexibly assigned to the robot R.

On the other hand, the cloud server 20 may assign elevators moving in the upward direction to both the robot and people even in the same peak time period, so that the robot R may vertically move within the building 1000 to provide services. Meanwhile, in a peak time period in which the movement direction of people is not concentrated in either the upward direction UP or the downward direction DOWN but occurs in both directions BOTH, the cloud server 20 may assign elevators to people on a priority basis regardless of the travel direction of the elevators EV1, EV2, EV3. That is, the cloud server 20 may set the operation mode of the elevators identically when the elevator is operated in the upward direction and when it is operated in the downward direction, and because this is the same as described above, the details will be omitted.

Meanwhile, in some example embodiments of the present disclosure, the robot R travels within the building 1000 to perform tasks assigned to the robot R, and in particular, may use an elevator when movement between floors is desired.

The tasks assigned to the robot R may be related to various services. For example, the robot R may be configured to perform a delivery task for a courier service, a food and beverage delivery task for a café service, a cleaning task, and a guidance task.

The cloud server 20 may provide convenience for people's use of elevators by adjusting task assignments for the robot R in the peak time period.

More specifically, in a peak time period in which people move in the upward direction, such as the commuting-to-work time (Up-Peak time period), the cloud server 20 may restrict the assignment of tasks that need or require movement in the upward direction. For example, a food and beverage delivery task from a café located in a lower-floor space (e.g., the 1st floor) to an office space located in an upper-floor space (e.g., floors above the 2nd floor) corresponds to a task of moving or traveling in the upward direction. The cloud server 20 may restrict the assignment of tasks related to café services to the robot R during the commuting-to-work time period, or may restrict the number of orders for café services.

Furthermore, the cloud server 20 may assign a plurality of tasks to a specific robot R to adjust so that only the specific robot R uses the elevator in the peak time period. For example, the cloud server 20 may simultaneously assign to a specific robot R a food and beverage delivery task corresponding to a first order and a food and beverage delivery task corresponding to a second order. That is, the cloud server 20 may assign a bundled delivery task to a specific robot R to control such that inconvenience to people is reduced or minimized even when the specific robot R uses the elevator.

The elevator assignment method and system according to some example embodiments of the present disclosure may classify a plurality of time periods into one of a first type of time period or a second type of time period based on elevator usage patterns of people in the building, and may specify a number of elevators to be assigned to the robot among a plurality of elevators provided in the building, depending on whether a particular time period is the first type of time period or the second type of time period. Through this, some example embodiments of the present disclosure may provide an improved or optimal elevator assignment method capable of reducing or minimizing inconvenience to people regarding elevator use and improving the efficiency of elevator use in an environment where people and robots coexist.

Furthermore, the elevator assignment method and system according to some example embodiments of the present disclosure may assign some (e.g., a portion) of the plurality of elevators to the robot in the first type of time period and an entirety of the plurality of elevators to the robot in the second type of time period, thereby providing an environment capable of satisfying the elevator use demand of people for each of the plurality of time periods while simultaneously providing robot services.

Meanwhile, some example embodiments of the present disclosure described above may be implemented as a program that is executed by one or more processors in a computer and is storable in a computer-readable medium.

Furthermore, some example embodiments of the present disclosure described above may be implemented as computer-readable code or instructions in a medium on which a program is recorded. That is, various control methods according to the present disclosure may be provided in the form of a program, either in an integrated or individual manner.

Meanwhile, the computer-readable medium includes all types of recording devices in which data readable by a computer system is stored. Examples of computer-readable media include HDD (Hard Disk Drive), SSD (Solid State Drive), SDD (Silicon Disk Drive), ROM, RAM, CD-ROM, magnetic tape, floppy disk, optical data storage devices, and the like.

Furthermore, the computer-readable medium may include storage and may be a server or cloud storage accessible by an electronic device through communication. In this case, the computer may download the program according to the present disclosure from a server or cloud storage through wired or wireless communication.

Furthermore, in the present disclosure, the computer described above is an electronic device equipped with a processor (e.g., a CPU (Central Processing Unit)), and no particular limitation is placed on the type thereof.

Any functional blocks shown in the figures and described above may be implemented in processing circuitry such as hardware including logic circuits, a hardware/software combination such as a processor executing software, or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, an application-specific integrated circuit (ASIC), etc.

Meanwhile, the detailed description above should not be construed as limiting in all respects and should be considered as illustrative. The scope of the present disclosure should be determined by reasonable interpretation of the appended claims, and all changes within the equivalent scope of the present disclosure are included in the scope of the present disclosure.

1. A method for elevator assignment in a building where people and robots coexist, the method comprising:
classifying a plurality of time periods into one of a first type of time period or a second type of time period based on elevator usage patterns of people in the building;
specifying a number of elevators to be assigned to a robot among a plurality of elevators provided in the building, depending on whether a particular time period is the first type of time period or the second type of time period,
wherein the number of elevators assigned to the robot in the first type of time period is less than the number of elevators assigned to the robot in the second type of time period.

2. The method of claim 1, further comprising:
determining an operation mode of the plurality of elevators based on the number of elevators assigned to the robot,
wherein the plurality of elevators are operated in one of a first mode that restricts boarding by the robot and prioritizes boarding by the people,
a second mode that does not restrict boarding by either the robot or the people, and
a third mode that restricts boarding by the people and prioritizes boarding by the robot.

3. The method of claim 2, wherein
in the first type of time period, a first group of the plurality of elevators are operated in the first mode and a second group of the plurality of elevators are operated in the third mode, and
in the second type of time period, all of the plurality of elevators are operated in the second mode.

4. The method of claim 3, wherein in the first type of time period, the number of elevators operated in the first mode is greater than the number of elevators operated in the third mode.

5. The method of claim 4, further comprising:
occurring an elevator boarding event of a first robot; and
assigning a boarding target elevator to the first robot,
wherein when the elevator boarding event occurs in the first type of time period, the assigning the boarding target elevator assigns an elevator operated in the third mode to a boarding group based on the boarding group including the first robot and one or more second robots being identified.

6. The method of claim 5, wherein the boarding group is identified based on the elevator boarding event in a same particular travel direction among an upward travel direction and a downward travel direction occurring in the first robot and the one or more second robots, and a number of the first robot and the one or more second robots corresponding to a reference number.

7. The method of claim 6, wherein the reference number corresponds to a maximum number of boarding robots set for the elevator operated in the third mode, and if a vertical movement paths of the first robot and the one or more second robots do not overlap, a plurality of robots equal to or greater than the reference number, including the first robot and the one or more second robots, are specified as the boarding group.

8. The method of claim 7, wherein the plurality of robots included in the boarding group are capable of moving from a current location of each of the plurality of robots to a waiting area of the elevator operated in the third mode within a reference unit time.

9. The method of claim 8, wherein the reference unit time is specified based on at least one of an operation speed of the elevator operated in the third mode or elevator usage patterns of the people in the first type of time period.

10. The method of claim 9, further comprising generating an operation schedule of the elevator operated in the third mode,
wherein the operation schedule is generated in consideration of at least one of a scheduled time for the plurality of robots to be positioned at the waiting area, a boarding time desired for the plurality of robots, an alighting time desired for the plurality of robots, or an operation speed of the elevator operated in the third mode.

11. The method of claim 2, wherein
in the first type of time period, a first group of the plurality of elevators are operated in the first mode and a second group of the plurality of elevators are operated in one of the first mode or the third mode, and
a switch to the third mode is made based on an occurrence of an elevator assignment event for the robot while the second group of the plurality of elevators are being operated in the first mode.

12. The method of claim 2, wherein
movement patterns of the people include an upward direction of moving from a lower floor to a higher floor and a downward direction of moving from an upper floor to a lower floor, and
if a main movement direction of the people in the first type of time period is the upward direction, among the plurality of elevators, an elevator operated in the upward direction is operated in one of the first mode or the third mode, and an elevator operated in the downward direction is operated in the second mode.

13. The method of claim 12, wherein a switch to the third mode is made based on occurrence of an elevator assignment event for the robot while an elevator operating in the upward direction is being operated in the first mode.

14. The method of claim 13, wherein if the main movement direction of the people in the first type of time period is the downward direction, among the plurality of elevators, an elevator operated in the downward direction is operated in one of the first mode or the third mode, and an elevator operated in the upward direction is operated in the second mode.

15. The method of claim 14, wherein the switch to the third mode is made based on occurrence of an elevator assignment event for the robot while an elevator operating in the downward direction is being operated in the first mode.

16. A system for elevator assignment in a building where people and robots coexist, the system comprising:
a controller configured to
classify a plurality of time periods into one of a first type of time period or a second type of time period based on elevator usage patterns of people in the building, and
specify a number of elevators to be assigned to a robot among a plurality of elevators provided in the building, depending on whether a particular time period is the first type of time period or the second type of time period,
wherein the number of elevators assigned to the robot in the first type of time period is less than the number of elevators assigned to the robot in the second type of time period.

17. A non-transitory computer-readable recording medium storing a program thereon, which when executed by one or more processors in an electronic device, causes the electronic device to implement a method for elevator assignment in a building where people and robots coexist, the method comprising:
classifying a plurality of time periods into one of a first type of time period or a second type of time period based on elevator usage patterns of people in the building; and
specifying a number of elevators to be assigned to a robot among a plurality of elevators provided in the building, depending on whether a particular time period is the first type of time period or the second type of time period,
wherein the number of elevators assigned to the robot in the first type of time period is less than the number of elevators assigned to the robot in the second type of time period.
